(19) United States
(12) Patent Application Publication
(10) Pub. No.: US 2017/0154133 A9
(43) Pub. Date: Jun. 1, 2017

(54) Modeling System and Method for Muscle Cell Activation

(71) Applicant: Daegu Gyeongbuk Institute of Science and Technology, Daegu (KR)

(72) Inventor: Ho Jeong Kim, Daegu (KR)

(21) Appl. No.: 14/680,809

(22) Filed: Apr. 7, 2015

(30) Foreign Application Priority Data
Aug. 19, 2014 (KR) 10-2014-0107832

(51) Int. Cl. G06F 17/50; G06F 17/10

(52) U.S. Cl. CPC G06F 17/5009; G06F 17/10

(57) ABSTRACT

Disclosed herein is modeling system and method of a muscle activation that is both biophysically-plausible and practically-robust over a wide range of physiological input conditions such as excitation frequency and muscle length. The modeling system comprises: a first module transforming electrical signals from motoneurons to concentration of Ca²⁺ in the sarcoplasm; a second module receiving the concentration of Ca²⁺ from the first module and transforming the concentration of Ca²⁺ to and activation dynamics of muscle; and a third module receiving the activation dynamics of muscle from the second module and transforming the activation dynamics of muscle to muscle force. The first module and the second module compensate a length dependency of the concentration of Ca²⁺ and the activation dynamics.

### CROSS-REFERENCE TO RELATED PATENT APPLICATIONS

This patent application claims priority to Korean Application No. 10-2014-0107832, filed Aug. 19, 2014, the entire teachings and disclosure of which are incorporated herein by reference thereto.

### BACKGROUND OF THE INVENTION

1. Field of the Invention

The present invention relates generally to modeling system and method for muscle cell activation and, in more detail, to modeling system and method of the muscle activation that is both biophysically-plausible and practically-robust over a wide range of physiological input conditions such as excitation frequency and muscle length.

2. Description of the Related Art

Body movement of animals is induced from the force developed by the contraction of skeletal muscles. The regulation of the muscle force has been well known to be dependent on not only the level of neural excitation from the spinal cord but also the shape of the muscle movement (Burke et al., 1973, Brown et al., 1996, Brown et al., 1998, Rassier et al., 1999). However, the simultaneous measurement of firing patterns of the motoneurons and resulting force production of the muscle during movement is still challenging due to current limitations in experimental techniques (Heckman and Enoka, 2012). Therefore, to systematically understand the neural control of the movement, there has been a need for a muscle model that can accept impulse train as an input and produce force output during the muscle movement.

The most popular muscle model used for simulation studies on human posture and movement would be the Hill-type model for the force production, probably due to the simplicity of its formulation and the ease with its implementation. (Zajac, 1989, Gerritsen et al., 1996, Sartori et al., 2012). Recent studies have directly compared the Hill-type muscle models currently used in large scale simulations to real data (Millard et al., 2013, Perreault et al., 2003, Sandercock and Heckman, 1997b). However, the similar conclusion has been made in those studies that the current Hill-type models may not have sufficient accuracy under physiological conditions. In particular, the errors between the models and experimental data were reported to be prominent over sub maximal range of neural excitation compared to the maximally excited case. In addition, the dependency of the activation dynamics on muscle movement was also confirmed while varying muscle length within a physiological range.

The errors of the Hill-type models may have been due to the difficulty in predicting the activation dynamics for those Hill-type models that has significantly hindered the advance in realistic simulations of neuro-musculo-seletal models under physiological input conditions (Campbell, 1997, Tanner et al., 2012). Typically the activation dynamics has been estimated either phenomenologically based on raw electromyography (EMG) data recorded from the muscle of interest (Thelen et al., 1994, Lloyd and Besier, 2003) or mechanistically solving the Huxley formulation that describes the spatiotemporal interaction of thin and thick myofilaments forming cross-bridges in the sarcomere (Laforet et al., 2011, Wong, 1971). Although the EMG-based models could be implemented relatively easier with small number of model parameters, it may be hard to get insights into details of the mechanisms underlying muscle activation as it concentrates on the overall performance of a muscular system. In contrast, the cross-bridge (or Huxley-type) models may provide a framework for mechanistically modeling the muscle activation, but the stiff nature of their system equations has raised a stability issue in numerically solving the equations in particular while varying model parameter values in a wide range (Zahalak, 1981, Zahalak and Ma, 1990).

As described above, the existing muscle models were developed in the abstract, so there are limits to model the muscle cell having various biophysical properties realistically.

### SUMMARY OF THE INVENTION

Accordingly, the present invention has been made keeping in mind the above problems occurring in the prior art, and an object of the present invention is to provide modeling systems and methods of the muscle cells to realistically reflect the major biophysical properties through developing a mathematical technique to determine experimentally the model parameter.

In order to accomplish the above object, the present invention provides a modeling system for muscle cell activation, comprising: a first module transforming electrical signals from motoneurons to concentration of Ca²⁺ in the sarcoplasm; a second module receiving the concentration of Ca²⁺ from the first module and transforming the concentration of Ca²⁺ to and activation dynamics of muscle; and a third module receiving the activation dynamics of muscle from the second module and transforming the activation dynamics of muscle to muscle force, wherein the first module and the second module compensate a length dependency of the concentration of Ca²⁺ and the activation dynamics.

The first module may comprise modeling of two compartments which consist of sarcoplasmic reticulum (SR) and sarcoplasm (SP).

The first module may transform the electrical signals from the motoneurons to the concentration of Ca²⁺ based on the sarcoplasmic reticulum (SR) model, the sarcoplasm (SP) model and cooperativity of chemical activation, as following equations (1) to (10):

ĆS=−K1·CS·Ca_{SR}+K2·Ca_{SR}CS (1);

Cá_{SR}=−K·CS·Ca_{SR}+K2·Ca_{SR}CS−R+U (2);

Ca_{ŚR}CS=K1·CS·Ca_{SR}−K2·Ca_{SR}CS (3);

$$\begin{matrix}R = {Ca}_{SR} \cdot {P}_{max} \cdot ( 1 - exp \frac{- t}{{τ}_{2}} ) \cdot exp \frac{- t}{{τ}_{3}} ; & ( 4 ) \\ U = {U}_{max} \cdot {( \frac{{Ca}_{SR}^{3} \cdot {K}^{3}}{1 + {Ca}_{SR} \cdot K + {Ca}_{SR}^{3} \cdot {K}^{2}} )}^{2} ; & ( 5 )\end{matrix}$$

\acute{B}=−K3·Ca_{SP}·B+K4·Ca_{SP}B (6);

Cá_{SP}=−K5·Ca_{SP}·T+K6·Ca_{SP}T−K3·Ca_{SP}·B+K4·Ca_{SP}B+R−U (7);

\acute{T}=−K5·Ca_{SP}·T+K6·Ca_{SP}T (8)

Ca_{ŚP}·B=K3·Ca_{SP}·B−K4·Ca_{SP}B (9);

Ca_{ŚP}T=K5·Ca_{SP}·T−K6·Ca_{SP}T (10)

(Ca_{SR}: the Ca2+ concentration in the SR, Ca_{SP}: the Ca2+ concentration in the SP, CS: calsequestrin), R: flux of Ca2+ release from the SR, U: flux of Ca2+ reuptake to the SR, K1 and K2: two rate constants that govern chemical reaction between free calcium ions and calsequestrin, Pₘₐₓ: maximum permeability of SR, and τ₁ time τ₂: constant of increase and decrease in permeability, Uₘₐₓ: maximal pump rate, K: site binding constant for Ca2+ to activate the pump in the sarcoplasmic reticulum, B: free buffer substances in thin filaments while interacting with SR via R and U, T: troponin in the thin filaments while interacting with SR via R and U, K3 and K4: forward and backward rate constants between Ca2+ and Ca2+-binding buffers (Ca_{SP}B), K5 and K6: forward and backward rate constants between Ca2+ and Ca2+-binding troponin (Ca_{SP}T), K6: a function of the muscle activation (A), K6=K6i/(1+5·A) where K6ᵢ is an initial rate constant.)

The second module may represent a steady-state relationship between Ca and force mapped Ca2+-binding troponin (Ca_{SP}T) and activation level (Ã) as following equation 11:

$$\dot{\tilde{A}} = \frac{{\tilde{A}}_{∞} - \tilde{A}}{{τ}_{\tilde{A}}} \\ where \\ {\tilde{A}}_{∞} = 0.5 \cdot ( 1 + tanh \frac{{Ca}_{SP} T / ( {Ca}_{SP} T + T ) - C 1}{C 2} ) , \\ {τ}_{\tilde{A}} = C 3 \cdot {( cosh \frac{{Ca}_{SP} T / ( {Ca}_{SP} T + T ) - C 4}{2 \cdot C 5} )}^{- 1} , \qquad ( 11 )$$

Ã_{∞} is the steady-state value of Ã at the normalized Ca_{SP}T relative to the total troponin concentration in the SP, τ_{Ã} is a time constant controlling speed at which the individual values of Ã_{∞} are approached, C1 is the normalized Ca_{SP}T for half muscle activation, C2 is a slope of activation curve at C1, C3 is a scaling factor for temperature, C4 is the normalized Ca_{SP}T for maximum time constant, and C5 determines width of the bell-shaped τ_{Ã} curve.

The second module may update the Ã(t) to the A(t) in exponential form as (Ã)^{α} with an exponent α assuming the reduction in likelihood of cross-bridge formation under impulse stimulation relative to the steady case for the transient Ca_{SP} variation during electrical excitation.

The third module may transform the activation dynamics to the muscle force based on the simplest form of Hill-based muscle models that consists of contractile and serial elastic element in series as following equation (12)-(15):

F=P₀·K_{SE}·(ΔXₘ−ΔX_{CE}) (12)

$$\begin{matrix}{X}_{CE}^{′} = \frac{- {b}_{0} \cdot ( {P}_{0} \cdot g ( {X}_{m} ) \cdot A ( t ) - F )}{F + {a}_{0} \cdot g ( {X}_{m} ) \cdot A ( t )} for F \leq {P}_{0} \cdot g ( {X}_{m} ) \cdot A ( t ) & ( 13 ) \\ {X}_{CE}^{′} = \frac{- {d}_{0} \cdot ( {P}_{0} \cdot g ( {X}_{m} ) \cdot A ( t ) - F )}{2 {P}_{0} \cdot g ( {X}_{m} ) \cdot A ( t ) - F + {c}_{0} \cdot g ( {X}_{m} ) \cdot A ( t )} \\ for F > {P}_{0} \cdot g ( {X}_{m} ) \cdot A ( t ) & ( 14 ) \\ g ( {X}_{m} ) = exp \{ - {( \frac{{X}_{m} - {g}_{2}}{{g}_{3 }} )}^{2} \} & ( 15 )\end{matrix}$$

where P₀ is the maximum muscle force at optimal muscle length, K_{SE} is the stiffness of the serial elastic element normalized with P₀, a₀, b₀, c₀ and d₀ are Hill-Mashma equation coefficients, g(Xₘ) is function of length-tension relation of muscle as a Gaussian function normalized with the P₀, g1-g3 are Gaussian coefficients indicating scaling factor, optimal muscle length and range of muscle length change, respectively.

a₀, b₀, c₀ and d₀ in the equations 14 and 15 may be analytically determined based on length-tension (L-T) and velocity-tension (V-T) property by deriving inverse equations for the four coefficients given four data points ((V_{S,1}, T_{S,1}), (V_{S,2}, T_{S,2}), (V_{L,1}, (V_{L,2}, T_{L,2})) on V-T curve where V_{S,1} and V_{S,2} are minimum and maximum shortening velocities, and V_{L,1} and V_{L,2} are minimum and maximum lengthening velocities as following equations 16 to 19:

$$\begin{matrix}{a}_{0} = \frac{{V}_{S , 2} \cdot {T}_{S , 2} \cdot ( {P}_{0} - {T}_{S , 2} ) - {V}_{S , 2} \cdot {T}_{S , 2} \cdot ( {P}_{0} - {T}_{S , 2} )}{{V}_{S , 2} \cdot ( {P}_{0} - {T}_{S , 2} ) - {V}_{S , 2} \cdot ( {P}_{0} - {T}_{S , 2} )} & ( 16 ) \\ {b}_{0} = \frac{{V}_{S , 2} \cdot {V}_{S , 2} \cdot ( {T}_{S , 2} - {T}_{S , 2} )}{{V}_{S , 2} \cdot ( {P}_{0} - {T}_{S , 2} ) - {V}_{S , 2} \cdot ( {P}_{0} - {T}_{S , 2} )} & ( 17 ) \\ {c}_{0} = \frac{\begin{matrix}( 2 \cdot {V}_{L , 2} \cdot {P}_{0} - {V}_{L , 2} \cdot {T}_{L , 2} ) \cdot ( {P}_{0} - {T}_{L , 2} ) + \\ ( {V}_{L , 2} \cdot {T}_{L , 2} - 2 {V}_{L , 2} \cdot {P}_{0} ) \cdot ( {P}_{0} - {T}_{L , 2} )\end{matrix}}{{V}_{L , 2} \cdot \{ {P}_{0 } - {T}_{L , 2} - {V}_{L , 2} \cdot ( {P}_{0 } - {T}_{L , 2} ) \}} & ( 18 ) \\ {d}_{0} = \frac{{V}_{L , 2} \cdot {V}_{L , 2} \cdot ( {T}_{L , 2} - {T}_{L , 2} )}{{V}_{L , 2} \cdot ( {P}_{0} - {T}_{L , 2} ) - {V}_{L , 2} \cdot ( {P}_{0} - {T}_{L , 2} )} . & ( 19 )\end{matrix}$$

A dependence of the activation dynamics on the muscle length during isometric and isokinetic contractions may be compensated by making the rate constant (K5) of the Ca2+-troponin reaction a function of the muscle length (Xm) as following equation 20,

$$K {5}^{*} = ϕ ( {X}_{m} ) \cdot K 5 , \{ \begin{matrix}ϕ ( {X}_{m} ) = {ϕ}_{1} \cdot {X}_{m} + {ϕ}_{2} for {X}_{m} < optimal \text{?} \\ ϕ ( {X}_{m} ) = {ϕ}_{3} \cdot {X}_{m} + {ϕ}_{4} for {X}_{m} \geq optimal length\end{matrix} \\ \text{?} \text{indicates text missing or illegible when filed} \qquad ( 20 )$$

where φ₀-φ₄ is determined using a curve fit tool built in Matlab for the data set (φ(Xₘ), Xₘ).

The dependence of the activation dynamics on dynamic movement may be compensated by adding a mathematical term to the exponent (α) of Ã(t) so that the a gradually increases during movement as following equation 21,

$$A = {( \tilde{A} )}^{α ( t )} , α ( t ) = α + {α}_{1} \cdot ( 1 + tanh \frac{t - {α}_{2}}{{α}_{3}} ) \qquad ( 21 )$$

where α₇, α₂ and α₃ is adjusted using the NEURON optimization tool to best fit the data at all three levels of constant frequency during movement.

The dependence of the activation dynamics on the muscle length and velocity during the dynamic movement may be compensated as following equation 22,

$$A = \frac{{( \tilde{A} )}^{α ( t )}}{( 1 + β \cdot ϕ ( {X}_{m} ) ) \cdot ( 1 + γ \cdot ( {V}_{m} ) )} \\ where α ( t ) = α + {α}_{1} \cdot ( 1 + tanh \frac{t - {α}_{2}}{{α}_{3}} ) , \qquad ( 22 )$$

α₁, α₂ and α₃ is adjusted using the NEURON optimization tool to best fit the data at all three levels of constant frequency during movement, φ(Xₘ) is the same function defined in equation 20, Vₘ are the time derivative of Xₘ, and β and γ were set to 0 for lengths longer than the optimal length or during negative velocity movement.

In order to accomplish the above object, the present invention also provides a modeling method for muscle cell activation, comprising: a first step transforming electrical signals from motoneurons to concentration of Ca²⁺ in the sarcoplasm; a second step receiving the concentration of Ca²⁺ from the first step and transforming the concentration of Ca²⁺ to and activation dynamics of muscle; and a third step receiving the activation dynamics of muscle from the second step and transforming the activation dynamics of muscle to muscle force, wherein the first step and the second step compensate a length dependency of the concentration of Ca²⁺ and the activation dynamics.

According to the present invention, generating muscle force is both realistically simulated under physiological conditions such as neural excitation and muscle movement and embodied in a general neuron simulator which reconstructs a realistic muscle cell model and simulates activation dynamics of the muscle cells.

According to the present invention, an accuracy of neuron-muscle simulation and understanding of a muscle force control which generates movements are improved.

According to the present invention, it is possible to model muscle cells so as to reflect experimental data which are generated by measuring biophysical properties.

According to the present invention, technological advancements are achieved in a rehabilitation field such as a neural-machine interface technique to recover ataxia and an advanced complement, a medical diagnosis equipment development field in which muscle functions and conditions are is diagnosed, and new medicine examination field.

### BRIEF DESCRIPTION OF THE DRAWINGS

The above and other objects, features and advantages of the present invention will be more clearly understood from the following detailed description taken in conjunction with the accompanying drawings, in which:

FIG. 1 shows schematic diagram of the modular muscle model according to present invention;

FIGS. 2A, 2B, 2C, 2D, 2E, and 2F show twitch and sub tetanic responses of the model and the real muscle (i.e. CT09) to various excitation frequencies (10, 20 and 40 Hz) at three different muscle lengths (−16 mm, −8 mm and 0 mm) centered at the optimal length;

FIGS. 3A, 3B, 3C, 3D, 3E, 3F, 3G, and 3H show length- and velocity-tension properties under full excitation;

FIG. 4 compares muscle force between the compensated model (dotted red) in the static condition and experimental data (solid black) from three levels (10, 20, and 30 Hz) of constant frequency during random variations in the length between −16 and 0 mm;

FIG. 5 shows force production during dynamic variation in both muscle length and excitation frequency;

FIGS. 6A and 6B show force production during dynamic variation of length and frequency in CT95;

FIGS. 7A, 7B, 7C, 7D, 7E, 7F, 7G, 7H, 7I, and 7J show the default parameter values for the CT95 model;

FIGS. 8A, 8B, and 8C show influence of the nonlinear Ca-force relationship on sub-tetanic responses in the model; and

FIG. 9 shows effect of a increase on the sub-tetanic responses of the model during movement.

### DESCRIPTION OF THE PREFERRED EMBODIMENTS

The inventors of the present invention first investigate how the excitation and the movement interact on the dynamics of muscle activation: dependencies of the activation dynamics on muscle movement and excitation frequency are identified by comparing the actual data obtained from a cat soleus muscle with its Hill-type model for both static and dynamic variation in the excitation frequency and muscle length. To incorporate the excitation and movement dependencies of the activation dynamics, we then present a novel modeling approach that allows for the prediction of the activation dynamics of Hill-type muscle models driven by electrical impulses (or spikes) during physiological movement. The signal transformations of the electrical spikes in the sarcoplasm for producing force are modeled in a modular form so that the model parameter values are determined by an individual module based on experimental data obtained under static conditions (i.e., isometric and isokinetic). Finally, the modified Hill-type model compensating for the dependencies of the activation dynamics on the frequency and length was validated using waveforms independent of those used to set the model parameters for cat soleus muscles.

Hereinafter, embodiments of the present invention will be described in detail with reference to the attached drawings. Those skilled in the art will appreciate that various modifications are possible, and the present invention is not limited to the following embodiment. Furthermore, the embodiment of the present invention aims to help those with ordinary knowledge in this art more clearly understand the present invention. The terms and words used for elements in the description of the present invention have been determined in consideration of the functions of the elements in the present invention. The terms and words may be changed depending on the intention or custom of users or operators, so that they should not be construed as limiting elements of the present invention.

Method

Experimental Data

Data for an average input-output properties of S-type muscle units were collected from the left hindlimb of two adult cats (i.e. one (CT09) for model development and the other (CT95) for model validation).

Briefly speaking, the cat was anesthetized with isoflurane (1.5-3.0%). The soleus muscle was exposed and its distal tendon was attached to a computer-controlled puller. All other distal hindlimb nerves except the soleus nerve were disconnected. Only ipsilateral dorsal roots from L4 to S2 were transected to eliminate sensory feedback from the soleus. Decerebration was performed at the midbrain level. Hindlimb and core temperatures were maintained within physiological limits using radiant heat. At the end of the experiment, animals were sacrificed with pentobarbital (100 mg/kg i.v.).

Excitation to the muscle was made by electrical stimulation using fine stainless steel wires in the proximal and distal portions of the muscle belly. Similar results were obtained with hook electrodes on the ventral roots. A stimulus intensity were set to be 50-100% above that required to elicit full recruitment to produce repeatable and consistent forces during all trials. Muscle length was controlled by a position servo system, a computer-controlled muscle puller (AV-50; ADI, Alexandria, Va.). This device had a stiffness of greater than 60 kN/m and a small signal position bandwidth of approximately 50 Hz. Muscle length was measured by an LVDT (500 DC-B; Shaevitz, Hampton, Va.) attached to the puller shaft. The muscle force was measured by a strain gage based transducer (Model 31 (stiffness >2 MN/m); Sensotec, Columbus, Ohio) in series with the shaft. Force and position data were sampled at 1 kHz (MIO-16; National Instruments, Austin, Tex.). To determine the active muscle response, the passive response to each perturbation was also measured and subtracted from those measured during muscle contractions.

The active muscle force was recorded during five experimental protocols making sure that the interval (at least 1 minute) between trials was large enough to prevent the fatigue: 1) twitch response at muscle lengths of −16 mm, −8 mm and 0 mm, 2) tetanic response with excitation frequencies of 10, 20 and 40 Hz at each muscle length, 3) Length-Tension (L-T) and Velocity-Tension (V-T) properties under full excitation (i.e. 100 Hz) (see Results for details), 4) step shortening of muscle length by 2 mm to estimate the stiffness of the serial elastic component of the muscle, and 5) random modulation of muscle length between 0 ˜−16 mm and excitation frequency.

The random variation of the muscle length was produced with bandwidth ranging from 0 to 5 Hz, matching soleus length changes during unrestrained locomotion (Goslow et al., 1973). The time course of the muscle length was generated by lowpass filtering a normally distributed random waveform. All length perturbations were centered about an operating point −8 mm less than physiological maximum. Maximum physiological length (0 mm) corresponded to approximately 4 mm beyond the peak of L-T curve. Stimulus trains had constant and uniformly distributed random interpulse intervals spanning the range from 0.01 s to twice the desired mean interpulse interval (10, 20 and 30 Hz).

Modular Modeling Framework

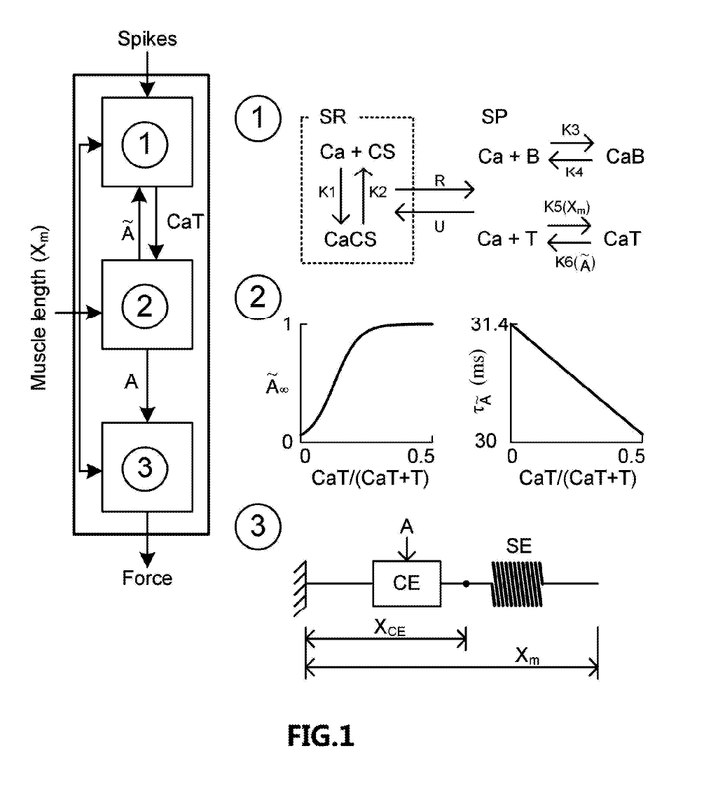

FIG. 1 shows schematic diagram of the modular muscle model according to present invention. The new model of the present invention in the left comprise three sub modules (, and ) including two inputs (spikes from spinal motoneurons and changes in muscle length) and force output. The activity of individual modules was described in the right. , the calcium (Ca) dynamics in the sarcoplasm (SP) and the sarcoplasmic reticulum (SR) in response to neural signals, CS, B, and T are the concentration of calsequestrin, Ca-buffering proteins and Ca-binding troponin, respectively; CaCS, CaB, and CaT are Ca bound to CS, Ca bound to B, and Ca bound to T, respectively; R and U are the rate functions for the release and uptake of Ca in the SR, respectively; K1-K6 are the rate constants, where K6 depends on the muscle activation (Ã) from the second sub-module. , Ã(t) is governed by the sigmoid relationship between CaT and the activation level (Ã_{∞}) in the steady state (left) and the time constant (τ_{Ã}) underlying the kinetics of reaching Ã_{∞} (right). Note that Ã(t) is updated to A(t) for the transient (i.e., spike) stimulation and dynamic movement (see the Methods and Results for details). , Hill mechanics to produce force output in response to A that is a function of neural signal and muscle length; CE and SE indicates contractile and serial elastic element; X_{CE} and Xₘ are length variables for CE and SE.

As shown in FIG. 1, the muscle model for force production in response to electrical spikes (i.e., neural commands) under movement consisted of three sub-modules (FIG. 1). The inventors of the present invention have chosen the mechanistic modeling approach not only for understanding the biological process underlying the muscle activation dynamics but also for extrapolating beyond the observed conditions by modulating model parameters such as rate constants (Laforet et al 2011, Williams et al 1998). The individual modules captured the biophysical characteristics of three signal transformations that the neural inputs undergo for force production. The electrical signals from the motoneurons were first transformed to the concentration of Ca2+ in the sarcoplasm via the first module (referred to as Module ). Then, the second module (referred to as Module ) was responsible for the transformation of Ca2+ concentration to the activation level. The last module (referred to as Module ) transformed the activation level to the muscle force. The new muscle model was implemented in the NEURON software environment which has been used as a general platform for computer simulations of neurons (Hines and Carnevale, 1997).

The first module (Module \textcircled{1}): The transformation of spike trains to the Ca2+ dynamics in the sarcoplasm was modeled based on chemical reactions suggested in the previous study (Westerblad and Allen, 1994). The features of the two-compartment modeling (sarcoplasmic reticulum (SR) and sarcoplasm (SP)) and cooperativity of activation (feedback of force information into the rate constant (K6) facilitating Ca2+-troponin binding) were maintained in the current modeling framework. The dynamics of calcium concentration (CaSR) in SR was determined by two rate constants (K1 and K2) that govern the chemical reaction between free calcium ions and calsequestrin (CS) giving following state equations,

ĆS=K1·CS·Ca_{SR}+K2·Ca_{SR}CS (1)

Cá_{SR}=−K·CS·Ca_{SR}+K2·Ca_{SR}CS−R+U (2)

Ca_{ŚR}CS=K1·CS·Ca_{SR}−K2·Ca_{SR}CS (3)

where R and U are the flux of Ca2+ release from SR and Ca2+ reuptake to SR, and modeled mathematically,

$$\begin{matrix}R = {Ca}_{SR} {P}_{max} \cdot ( 1 - exp \frac{- t}{{τ}_{2}} ) \cdot exp \frac{- t}{{τ}_{3}} & ( 4 ) \\ U = {U}_{max} \cdot {( \frac{{Ca}_{SR}^{3} \cdot {K}^{3}}{1 + {Ca}_{SR} \cdot K + {Ca}_{SR}^{3} \cdot {K}^{2}} )}^{2} & ( 5 )\end{matrix}$$

where Pmax is the maximum permeability of SR, τ1 and τ2 are the time constant of increase and decrease in permeability, Umax is the maximal pump rate, K is the site binding constant for Ca2+ to activate the pump in the sarcoplasmic reticulum.

The Ca2+ concentration (CaSP) in SP of this module was then controlled by the interaction with free buffer substances (B) and troponin (T) in the thin filaments while interacting with SR via R and U. The reactions between these chemical substances were governed by four reaction constants (K3-K6) following the state equations,

\acute{B}=−K3·Ca_{SP}·B+K4·Ca_{SP}B (6)

Cá_{SP}=−K5·Ca_{SP}·T+K6·Ca_{SP}T−K3·Ca_{SP}·B+K4·Ca_{SP}B+R−U (7)

\acute{T}=−K5·Ca_{SP}·T+K6·Ca_{SP}T (8)

Ca_{ŚP}·B=K3·Ca_{SP}·B−K4·Ca_{SP}B (9);

Ca_{ŚP}T=K5·Ca_{SP}·T−K6·Ca_{SP}T (10)

where K3 and K4 are forward and backward rate constants between Ca2+ and Ca2+-binding buffers (CaSPB), K5 and K6 are forward and backward rate constants between Ca2+ and Ca2+-binding troponin (Ca_{SP}T). K6 are a function of the muscle activation (A): K6=K6i/(1+5·A) where K6i is an initial rate constant.

The second module (Module \textcircled{2}): The second module was modeled based on the sigmoidal relationship between the Ca2+ concentration (CaSP) in the sarcoplasm and force in the steady state as reported in the previous studies (Shames et al., 1996).

In this module, the steady-state relationship between Ca and the force was first mapped to that of Ca_{SP}T and the activation level (Ã) for the steady Ca stimulation. Morris-Lecar formulation, including five parameters (C1-C5) (Morris and Lecar 1981), was chosen to dynamically represent the nonlinear Ca_{SP}T−Ã relationship using the following equations,

$$\dot{\tilde{A}} = \frac{{\tilde{A}}_{∞} - \tilde{A}}{{τ}_{\tilde{A}}} \\ {\tilde{A}}_{∞} = 0.5 \cdot ( 1 + tanh \frac{{Ca}_{SP} T / ( {Ca}_{SP} T + T ) - C 1}{C 2} ) and \\ {τ}_{\tilde{A}} = C 3 \cdot {( cosh \frac{{Ca}_{SP} T / ( {Ca}_{SP} T + T ) - C 4}{2 \cdot C 5} )}^{- 1} \qquad ( 11 )$$

where Ã_{∞} is the steady-state value of Ã at the normalized Ca_{SP}T relative to the total troponin concentration in the SP, τ_{Ã} is the time constant controlling the speed at which the individual values of Ã_{∞} are approached, C1 is the normalized Ca_{SP}T for half muscle activation, C2 is the slope of the activation curve at C1, C3 is the scaling factor for temperature, C4 is the normalized Ca_{SP}T for the maximum time constant, and C5 determines the width of the bell-shaped τ₂ curve.

Then, for the transient Ca_{SP} variation during electrical excitation, the Ã(t) was updated to the A(t) in exponential form as (Ã)^{α} with an exponent α assuming the reduction in the likelihood of the cross-bridge formation under the impulse stimulation relative to the steady case. The third module (Module): The transformation of A to the muscle force was modeled based on the simplest form of Hill-based muscle models that consists of two elements, contractile and serial elastic element, in series (Zajac, 1989). In this module, the force output (F) was determined by the difference between the deviation of contractile (ΔXCE) and serial elastic element (ΔXm) relative to their initial lengths.

F=P₀·K_{SE}·(ΔXₘ−ΔX_{CE}) (12)

where P0 is the maximum muscle force at the optimal muscle length, KSE is the stiffness of the serial elastic element normalized with P0.

To calculate the ΔXCE in Eq. (12) under various ranges of muscle length and activation level, the original equations suggested by Hill for shortening of muscle length and Mashima (Mashima et al., 1972) for lengthening of muscle length were modified as follows,

$$\begin{matrix}{X}_{CE}^{′} = \frac{- {b}_{0} \cdot ( {P}_{0} \cdot g ( {X}_{m} ) \cdot A ( t ) - F )}{F + {a}_{0} \cdot g ( {X}_{m} ) A ( t )} , for F \leq {P}_{0} \cdot g ( {X}_{m} ) \cdot A ( t ) & ( 13 ) \\ {X}_{CE}^{′} = \frac{- {d}_{0} \cdot ( {P}_{0} \cdot g ( {X}_{m} ) \cdot A ( t ) - F )}{2 {P}_{0} \cdot g ( {X}_{m} ) \cdot A ( t ) - F + {c}_{0} \cdot g ( {X}_{m} ) A ( t )} , \\ for F > {P}_{0} \cdot g ( {X}_{m} ) \cdot A ( t ) & ( 14 ) \\ g ( {X}_{m} ) = exp \{ - {( \frac{{X}_{m} - {g}_{2}}{{g}_{3 }} )}^{2} \} & ( 15 )\end{matrix}$$

where a0, b0, c0 and d0 are Hill-Mashma equation coefficients, g(Xm) is the function of length-tension relation of the muscle as a Gaussian function (i.e., bell-shaped) normalized with the P0, g1-g2 are Gaussian coefficients indicating scaling factor, optimal muscle length and range of muscle length change, respectively.

The Eq. (12)-(15) were also used to inversely estimate the activation dynamics (A(t)) for a given muscle force (F) and length profile (Xm).

Determination of Model Parameter Values

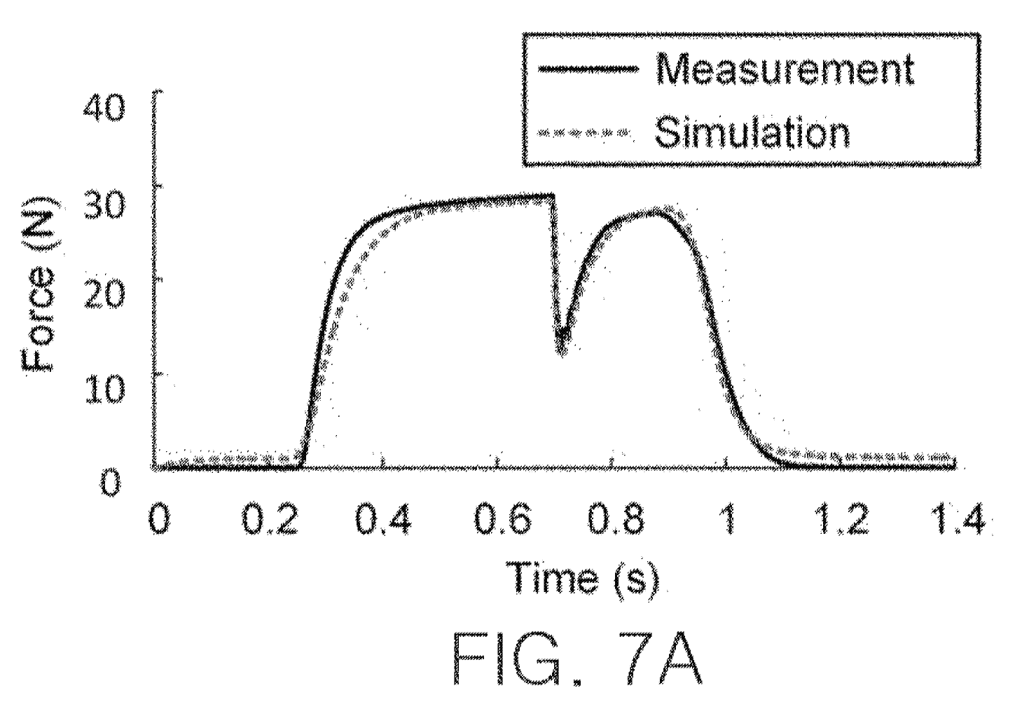

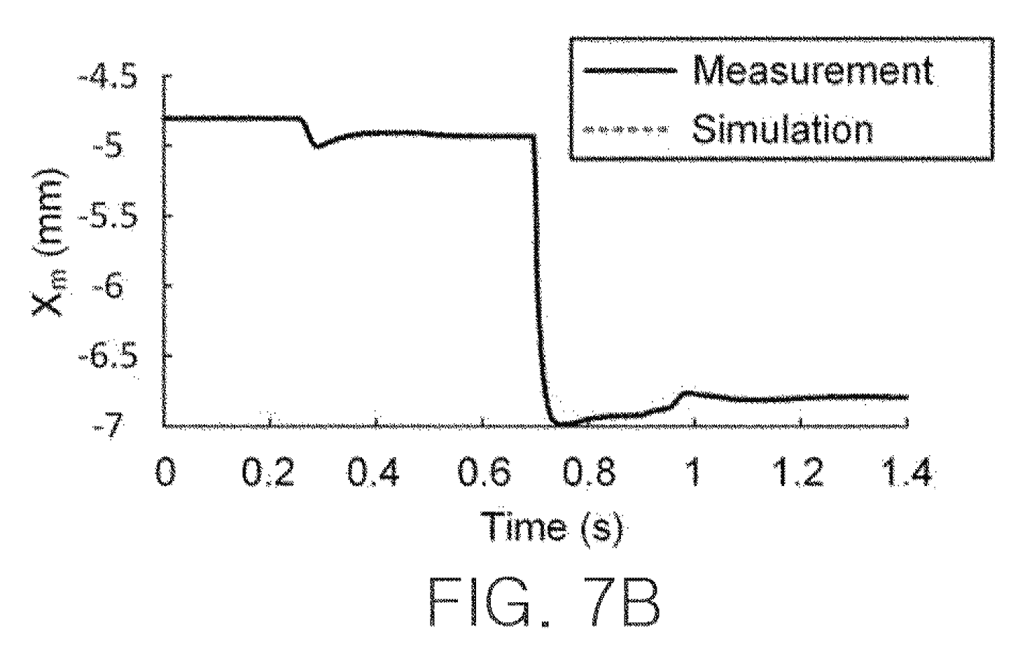

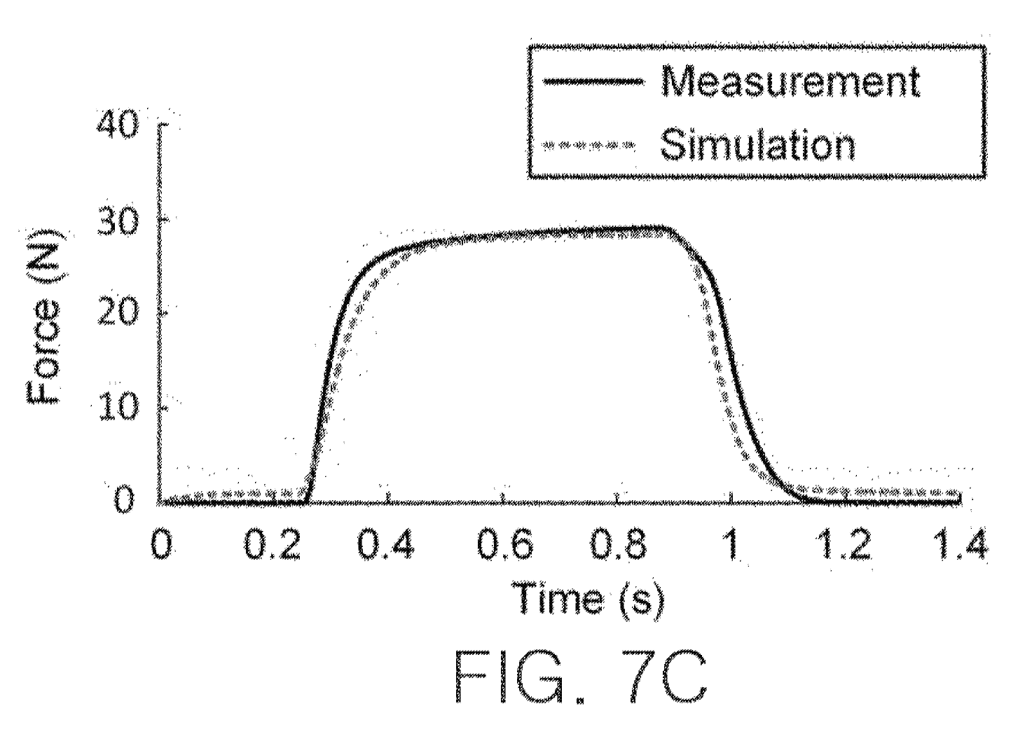

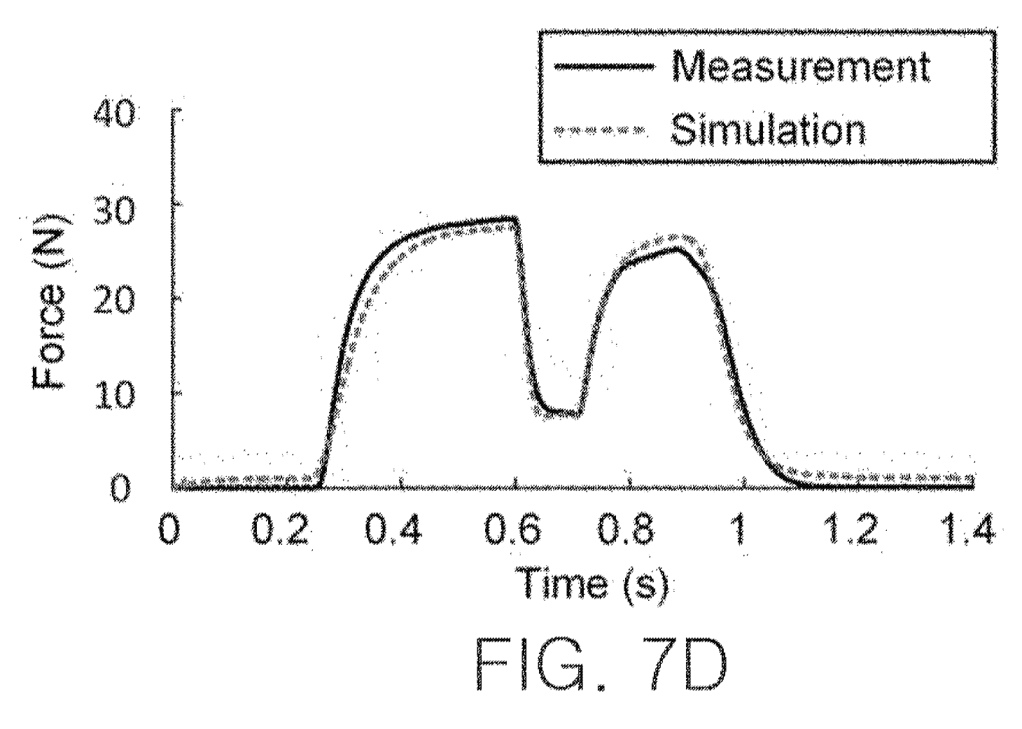

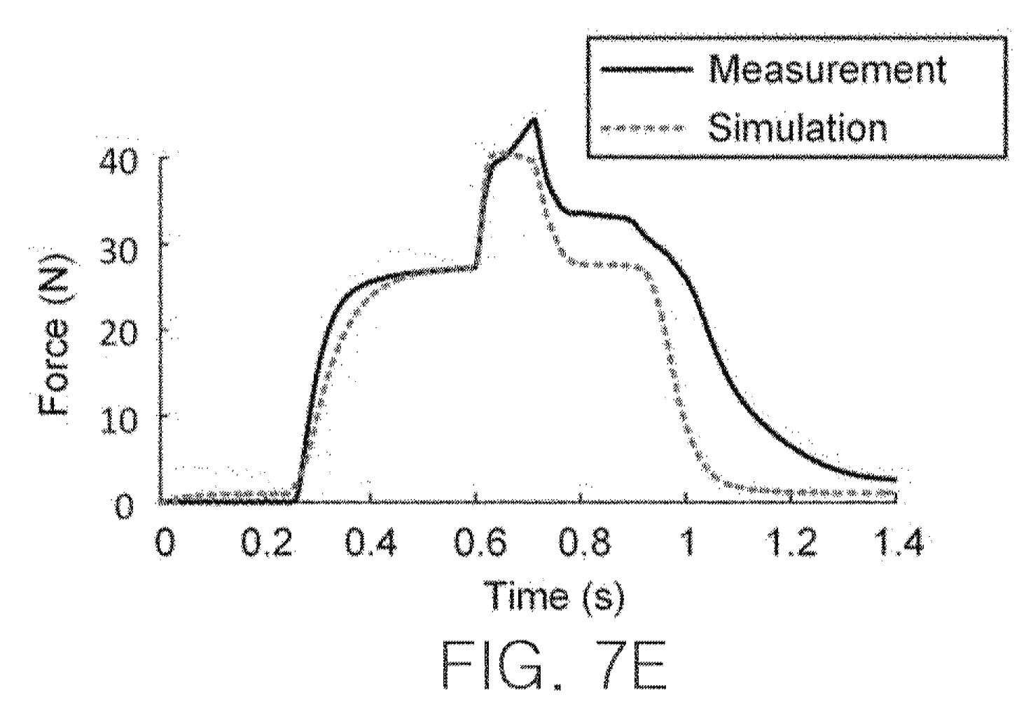

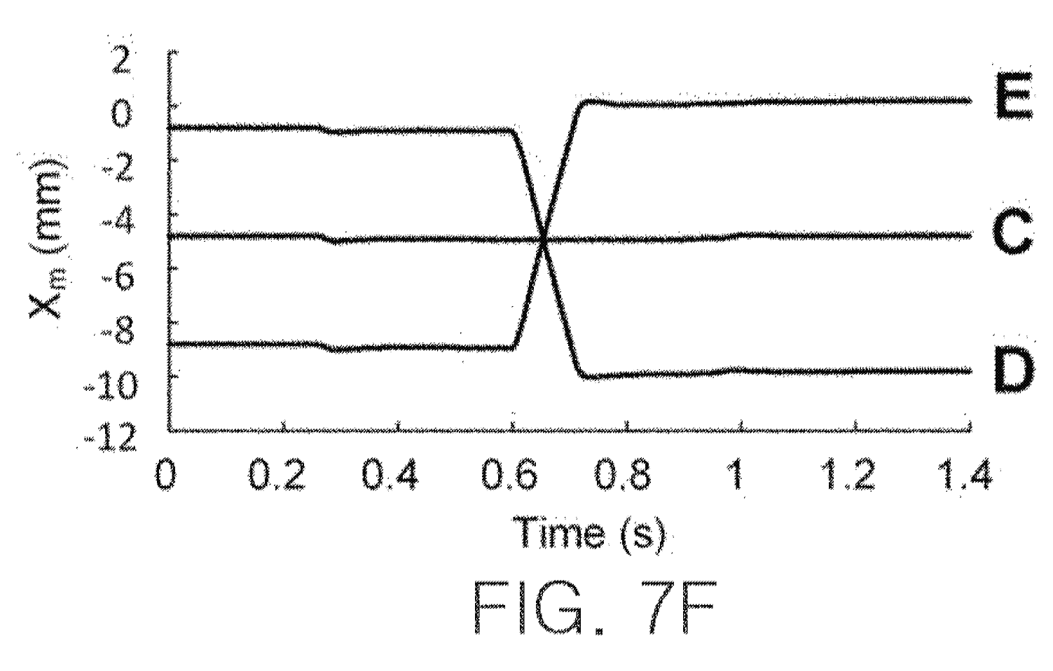

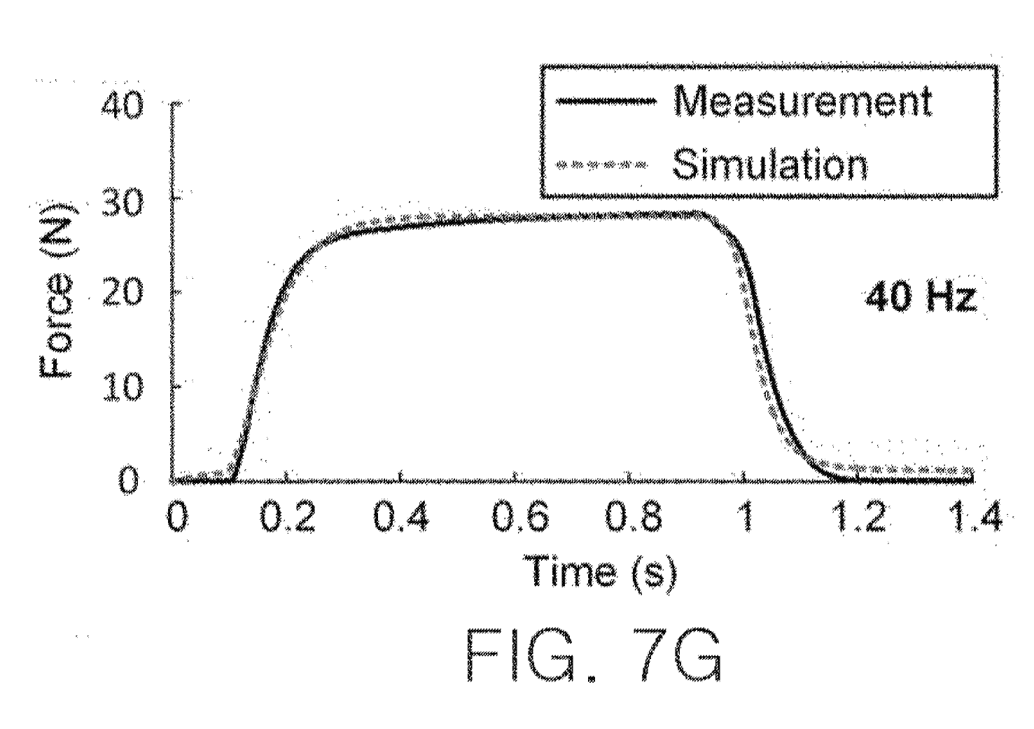

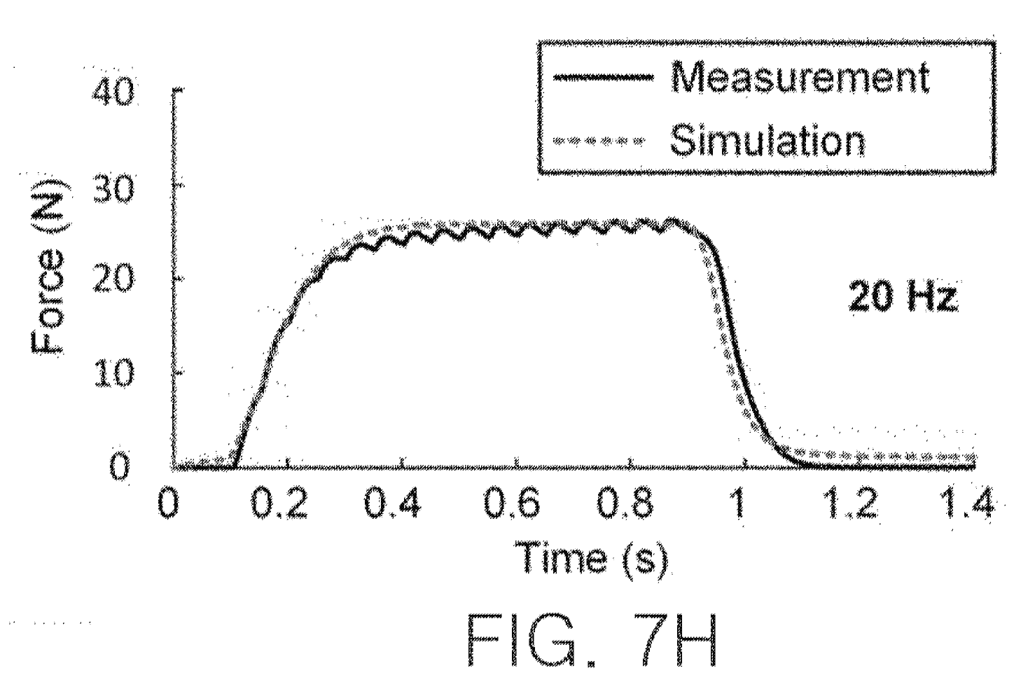

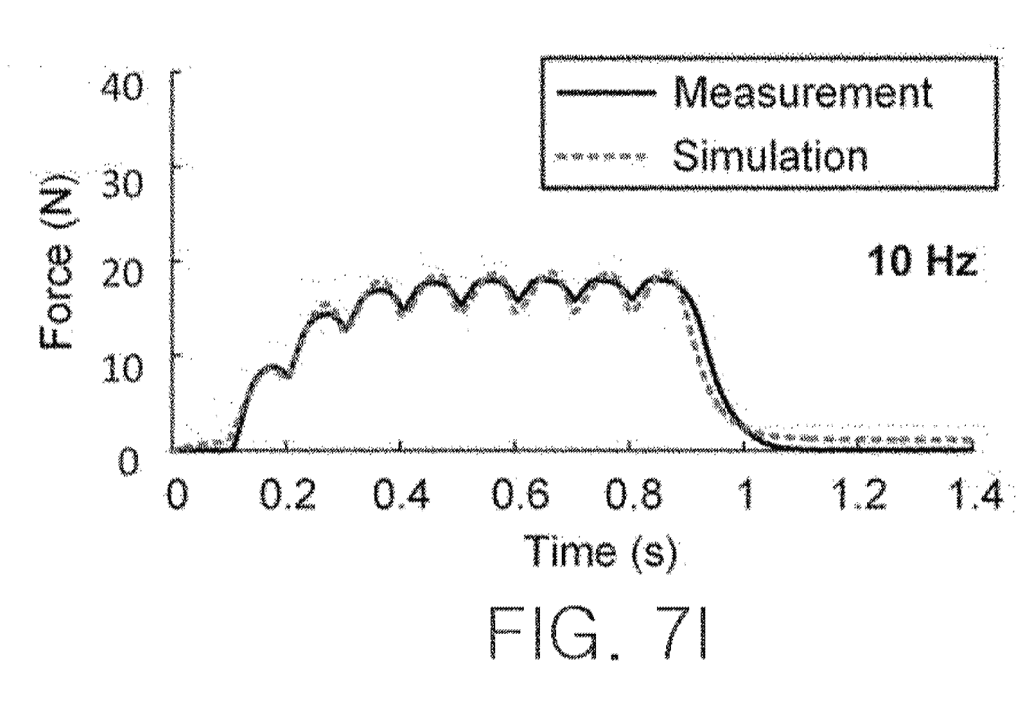

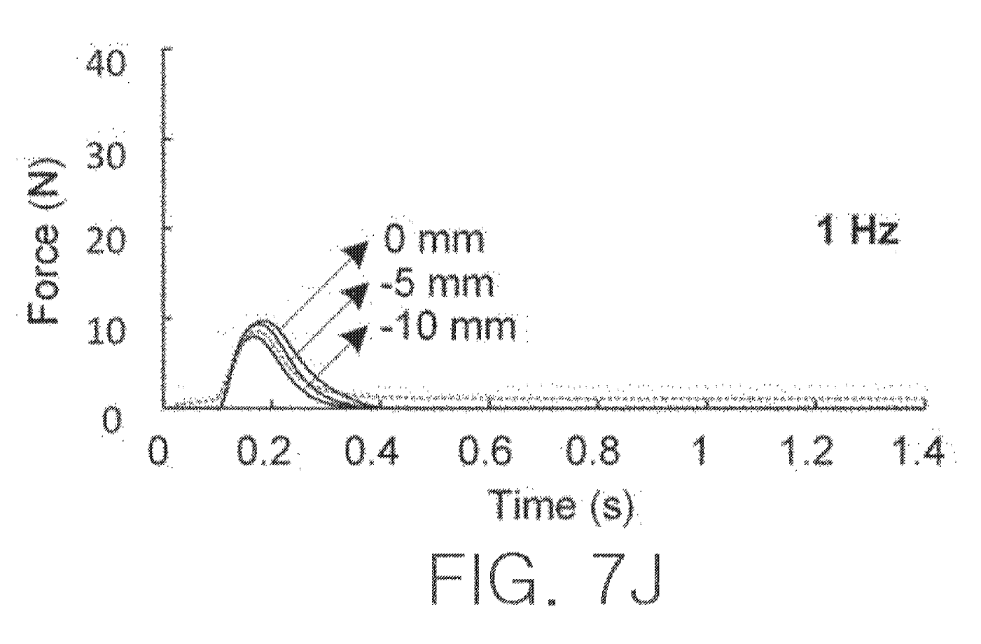

The parameter values were determined separately for the individual modules based directly from experimental data. In the present study, all parameter values of the first module were adopted directly from the literature that has been experimentally identified from mice preparations (Westerblad and Allen, 1994). The parameter values of the third module were analytically determined based on two experimental conditions. K_{SE} in Eq. (12) was first determined assuming that the change of contractile element is negligible while instantaneously shortening the muscle length during isometric contraction with full excitation (see FIGS. 7A and 7B). Given the data of change in muscle length and force, K_{SE} was calculated using the Eq. (12). Hill and Mashma coefficients (i.e. a₀-d₀ in Eq. (13) to (15)) were analytically determined based on length-tension (L-T) and velocity-tension (V-T) property by deriving inverse equations for the four coefficients given four data points ((V_{S,1}, T_{S,1}), (V_{S,2}, T_{S,2}), (V_{L,1}, T_{L,1}), (V_{L,2}, T_{L,2})) on the V-T curve where V_{S,1} and V_{S,2} are minimum and maximum shortening velocities, and V_{L,1} and V_{L,2} are minimum and maximum lengthening velocities,

$$\begin{matrix}{a}_{0} = \frac{{V}_{S , 1} \cdot {T}_{S , 1} \cdot ( {P}_{0} - {T}_{S , 2} ) - {V}_{S , 2} \cdot {T}_{S , 2} \cdot ( {P}_{0} - {T}_{S , 1} )}{{V}_{S , 2} \cdot ( {P}_{0} - {T}_{S , 1} ) - {V}_{S , 1} \cdot ( {P}_{0} - {T}_{S , 2} )} & ( 16 ) \\ {b}_{0} = \frac{{V}_{S , 2} \cdot {V}_{S , 1} \cdot ( {T}_{S , 1} - {T}_{S , 2} )}{{V}_{S , 1} \cdot ( {P}_{0} - {T}_{S , 2} ) - {V}_{S , 2} \cdot ( {P}_{0} - {T}_{S , 1} )} & ( 17 ) \\ {c}_{0} = \frac{\begin{matrix}( 2 \cdot {V}_{L , 1} \cdot {P}_{0} - {V}_{L , 2} \cdot {T}_{L , 1} ) \cdot ( {P}_{0} - {T}_{L , 2} ) + \\ ( {V}_{L , 2} - {T}_{L , 2} - 2 \cdot {V}_{L , 1} \cdot {P}_{0} ) \cdot ( {P}_{0} - {T}_{L , 1} )\end{matrix}}{{V}_{L , 1} \cdot \{ {P}_{0} - {T}_{L , 2} - {V}_{L , 2} \cdot ( {P}_{0} - {T}_{L , 1} ) \}} & ( 18 ) \\ {d}_{0} = \frac{{V}_{L , 1} \cdot {V}_{L , 2} \cdot ( {T}_{L , 1} - {T}_{L , 2} )}{{V}_{L , 2} \cdot ( {P}_{0} - {T}_{L , 2} ) - {V}_{L , 2} \cdot ( {P}_{0} - {T}_{L , 2} )} & ( 19 )\end{matrix}$$

where V_{S,1} and V_{S,2} are the minimum and maximum shortening velocities and V_{L,1} and V_{L,2} are the minimum and maximum lengthening velocities. The four data points measured to determine the four Hill-Mashma coefficients were (−160, 1), (−1, 22), (1, 23.5), and (80, 34.35) for CT09 and (−80, 8), (−1, 28), (1, 29.5), and (80, 43) for CT95, where the units are mm/s and N for velocity and tension, respectively.

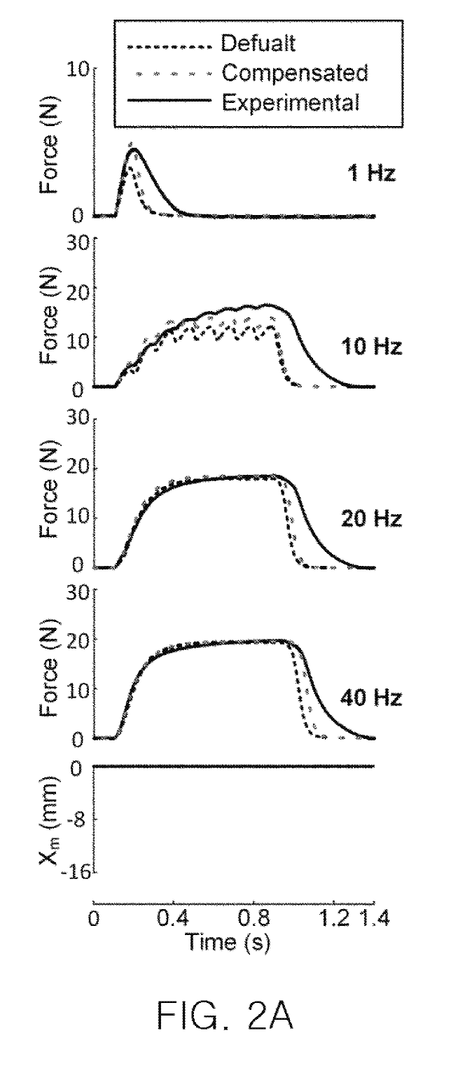

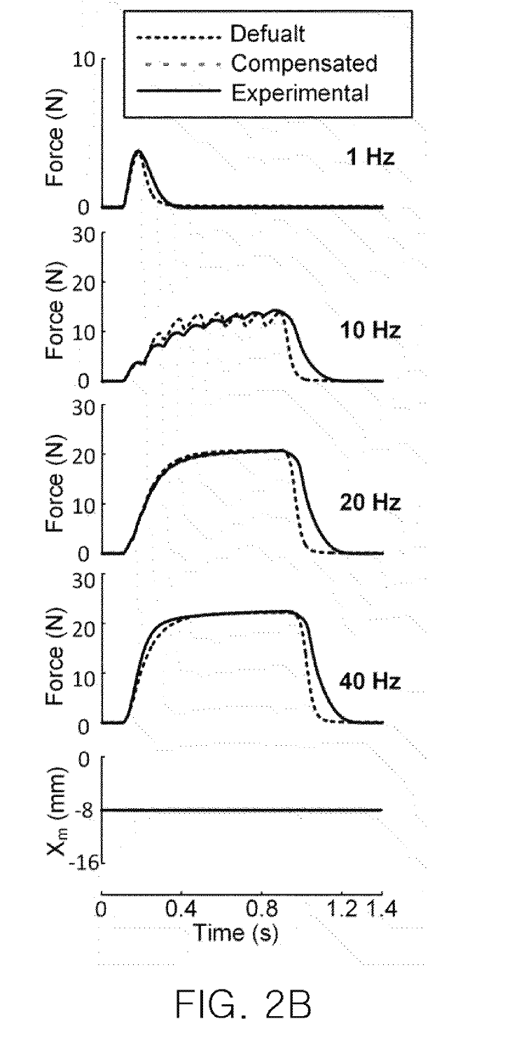

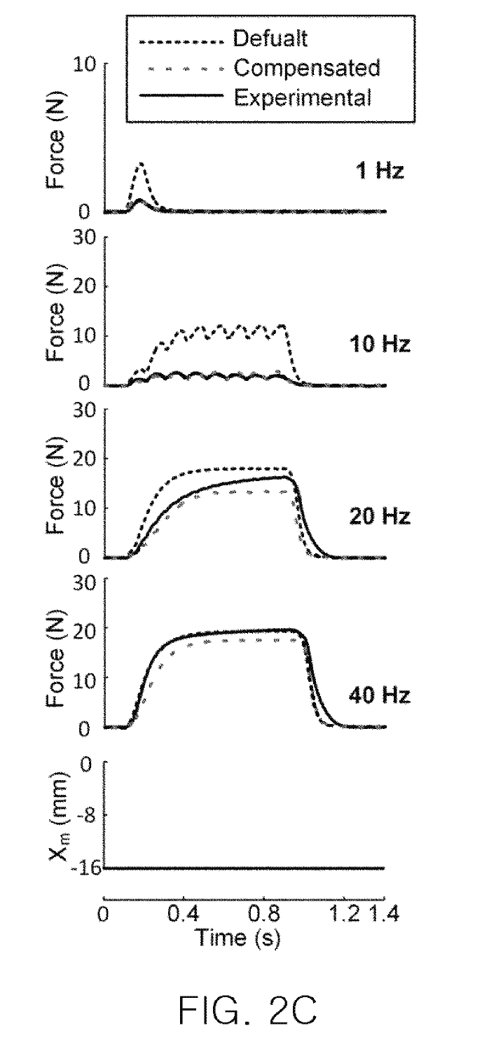

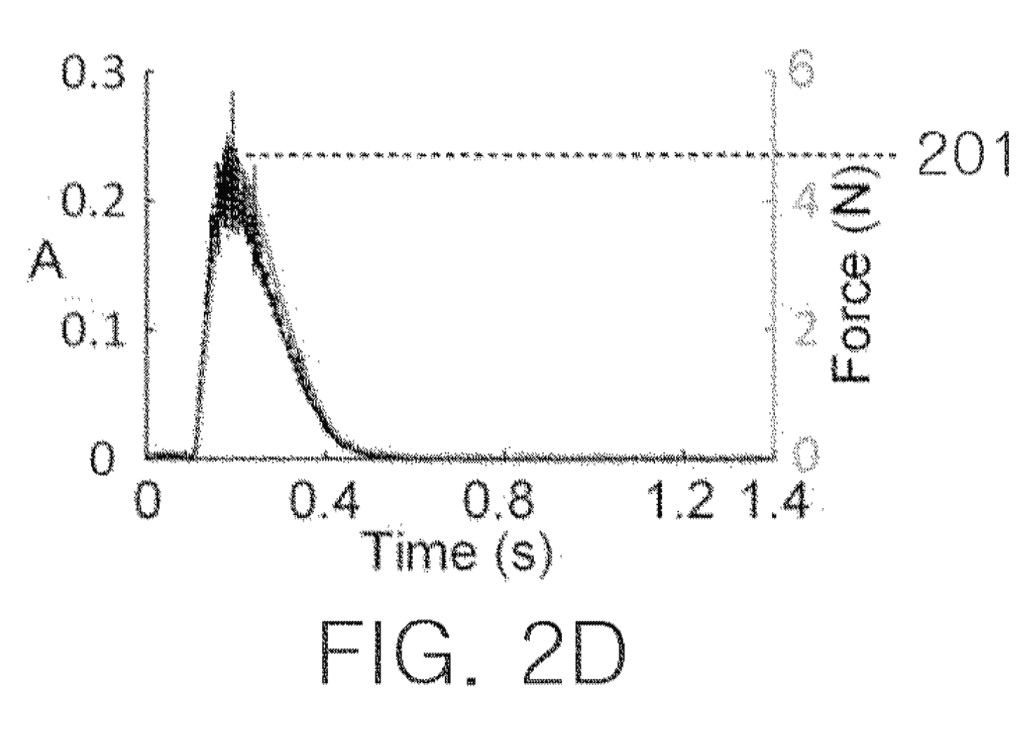

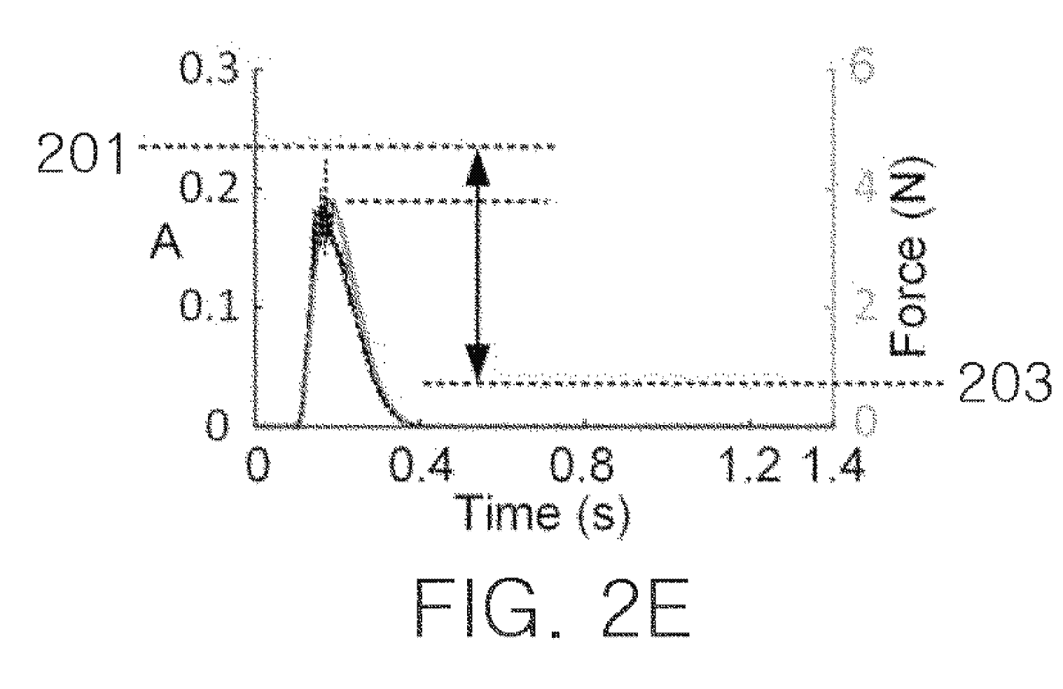

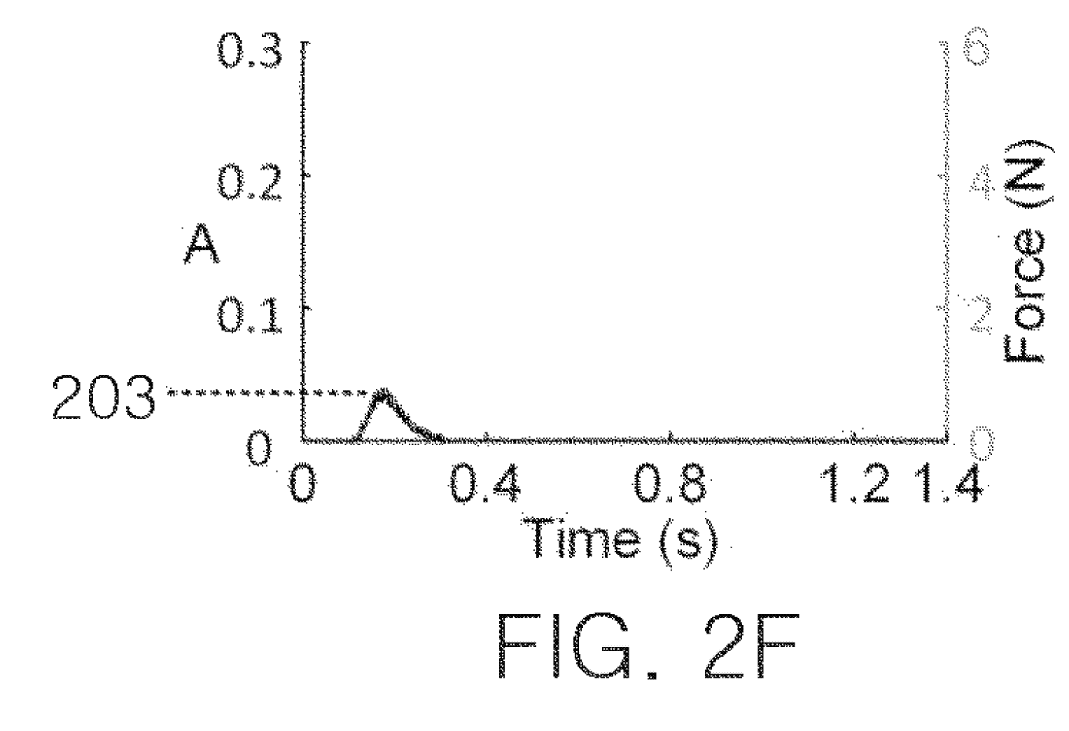

The parameter values (C1-C5) of the second module were adjusted to match experimental data for twitch and sub tetanus responses with excitation frequency ranging from 1 to 40 Hz at the optimal muscle length (see FIG. 2E for details of muscle force). The optimization of the parameter values was done using the optimization tool built in the NEURON software (Hines and Carnevale, 1997).

All steps were repeated for the different set of experimental data obtained from another cat preparation (i.e. CT95) to validate the modeling approach proposed in the present study. All parameter values used for the present study were presented in Table 1.

TABLE 1
Model parameters ans values

| | Parameter | CT09 | CT95 |
|---|---|---|---|
| Module \textcircled{1} | K1 [M⁻¹s⁻¹] | 3000 | 3000 |
| | K2 [s⁻¹] | 3 | 3 |
| | K3 [M⁻¹s⁻¹] | 400 | 400 |
| | K4 [s⁻¹] | 1 | 1 |
| | K5 [M⁻¹s⁻¹] | 4e5 | 4e5 |
| | K6ᵢ [s⁻¹] | 150 | 150 |
| | K [M⁻¹s⁻¹] | 850 | 850 |
| | Rₘₐₓ [s⁻¹] | 10 | 10 |
| | Uₘₐₓ [M⁻¹s⁻¹] | 2000 | 2000 |
| | τ₁ [ms] | 3 | 3 |
| | τ₂ [ms] | 25 | 25 |
| | φ₁ | 0.03 | 0.006 |
| | φ₂ | 1.23 | 1.03 |
| | φ₃ | 0.01 | 0.006 |
| | φ₄ | 1.08 | 1.03 |
| Module \textcircled{2} | C1 | 0.128 | 0.118 |
| | C2 | 0.093 | 0.11 |
| | C3 [ms] | 61.206 | 68.319 |
| | C4 | −13.116 | −3.94 |
| | C5 | 5.095 | 1.368 |
| | α | 2 | 2 |
| | α₁ | 4.77 | 2 |
| | α₂ [ms] | 400 | 400 |
| | α₃ [ms] | 160 | 160 |
| | β [mm⁻¹] | 0.47 | 0.001 |
| | γ [s/mm] | 0.001 | 0.001 |
| Module \textcircled{3} | K_{SE} [mm⁻¹] | 0.4 | 0.57 |
| | P₀ [N] | 23 | 28.9 |
| | g₁ [mm] | −8 | −5 |
| | g₂ [mm] | 21.4 | 27.5 |
| | a₀ [N] | 2.35 | 0.18 |
| | b₀ [mm/s] | 24.35 | 31.31 |
| | c₀ [N] | −7.4 | −9.19 |
| | d₀ [mm/s] | 30.3 | 31.86 |

φ₁-φ₄ are the parameters of Eq. 20 for compensating the length dependency of A(t) in the static conditions. α-α₃, β, and γ are the parameters of Eq. 22 for compensating the dependencies of A(t) during movement. The definition of individual parameters and the procedure of determining parameter values were fully described in the Methods section.

Identification of a(t) Dependency on Excitation and Movement

The dependency of A(t) on excitation frequency and muscle length was investigated based on the indirect method that has been used in our previous studies (Perreault et al 2003, Sandercock and Heckman 1997b). This method utilizes only the Module in our modeling framework. Given the length and force data from the soleus muscle (CT09), A(t) for the Module was first estimated inversely from Eqs. (12)-(14). Then, the force production was compared between the real and model muscle with the inversely estimated A(t) while varing the length to identify the movement dependency of A(t). For the excitation dependency of A(t), the above process was repeated at various levels of excitation frequency. In the present study, this indirect investigation was performed for the static (isometric and isokinetic) conditions. During the dynamic (movement) conditions, the muscle model compensating for the identified dependencies of A(t) during the static (isometric and isokinetic) conditions was compared with the force data obtained from the soleus muscle under the same excitation and movement condition. The profiles of A(t) inversely estimated for the dynamic conditions were presented in detail in our previous paper (Perreault et al 2003).

Numerical Simulations

The new muscle model, consisting of the three sub-modules, was implemented using the Neuron MOdel Description Language (NMODL) in the NEURON software environment (version 6.1). NEURON has been used as a general platform for computer simulations of real neurons (Perreault et al 2003). Applying the same stimulation protocols as those in the experiments, the model was simulated using a numerical integration method (cnexp) built in the NEURON with a fixed time step (0.025 ms) ensuring the stability and accuracy of simulations while varying parameter values in a wide range. The initial values of the Ca_{SR} and CS in the SR, and the B and T in the SP were set to 2.5 mM, 30 mM, 0.43 mM, and 70 μM, as reported in a previous study (Williams et al 1998, Laforet et al 2011).

Results

Dependency of the muscle activation dynamics (A(t) in FIG. 1) on excitation (stimulation frequency) and movement (muscle length) was first investigated for twitch and sub-tetanic contractions at discrete lengths (i.e., isometric). After compensating the modified Hill model (FIG. 1) with the default parameter values (Table 1) for the identified dependence of A(t) during the isometric contractions, we further evaluated the movement dependence of A(t) during tetanic contractions over a wide range of constant velocities (i.e., isokinetic). Then, we tested the model compensating for all of the identified dependencies of A(t) in the static conditions for the dynamic cases where the frequency and length dynamically varied. Finally, we validated the model compensating for the identified dependencies of A(t) under the dynamic conditions against the real data obtained from the different muscle preparation (CT95).

Twitch and Sub Tetanic Responses at Various Muscle Lengths

FIGS. 2A, 2B, 2C, 2D, 2E, and 2F show twitch and sub tetanic responses of the model and the real muscle (i.e. CT09) to various excitation frequencies (10, 20 and 40 Hz) at three different muscle lengths (−16 mm, −8 mm and 0 mm) centered at the optimal length. The default values for the model parameters (Table 1) were determined to match the force data (FIG. 2B) measured at the optimal length in the same muscle. In FIGS. 2A to 2C, the twitch and sub-tetanic responses of the models and an actual muscle (solid black lines) at three muscle lengths (Xₘ) of 0 (FIG. 2A), −8 (FIG. 2B), and −16 mm (FIG. 2C) under constant excitation with frequencies of 1, 10, 20, and 40 Hz. The black dotted lines indicate the responses of the model with default parameter values adjusted for the actual data in FIG. 2B. The dotted red lines in FIGS. 2A and 2C indicate the responses of the default model after compensating for the length dependency of A(t) using Eq. (20). In FIGS. 2D to 2F, activation dynamics (A, dotted black lines) inversely calculated using Eqs. (12)-(15) directly from the twitch responses (gray lines) measured at three different lengths: 0 mm (FIG. 2D), −8 mm (FIG. 2E), and −16 mm (FIG. 2F).

The force output of the model was underestimated when the lengths were greater than optimal length (FIG. 2A), whereas it was overestimated when shortened (FIG. 2C). To explicitly determine whether A(t) depends on the length, A(t) was inversely estimated from the twitch response (black dotted lines in FIG. 2D-2F) of actual muscle at each length using Eqs. (12)-(15). The degree of change in the amplitude of A(t) was more severe when reducing the length, rather than increasing it. This dependence of the activation amplitude on length was compensated for by making the forward rate constant (K5 in FIG. 1) of the Ca²⁺-troponin reaction a function of the length (Xₘ), as suggested in a previous study (Groning et al 2013):

$$K {5}^{*} = ϕ ( {X}_{m} ) \cdot K 5 , \{ \begin{matrix}ϕ ( {X}_{m} ) = {ϕ}_{1} \cdot {X}_{m} + {ϕ}_{2} for {X}_{m} < optimal \text{?} \\ ϕ ( {X}_{m} ) = {ϕ}_{3} \cdot {X}_{m} + {ϕ}_{4} for {X}_{m} \geq optimal length\end{matrix} \\ \text{?} \text{indicates text missing or illegible when filed} \qquad ( 20 )$$

where φ₁-φ₄ are determined using a curve fit tool built in Matlab for the dataset {(φ(Xₘ), Xₘ)|(0.77, −16), (1, −8), (1.08, 0)}, in which the model matched the peak of the twitch response measured at the three lengths (FIG. 2D-2F).

After compensating the length dependency of the activation dynamics, the model error with respect to real data was dramatically reduced in particular for the low level (below 40 Hz) of excitation frequencies (see FIGS. 2A and 2C). At the high level of excitation frequency (over 40 Hz), there was no significant difference in the force production regardless of the compensation for the length dependence. This result lead us to the expectation that under the full excitation the activation dynamics might not be influenced too much by the constant change in the muscle length over time (i.e. isovelocity condition).

Isometric-Isovelocity-Isometric Contractions Under Full Excitation

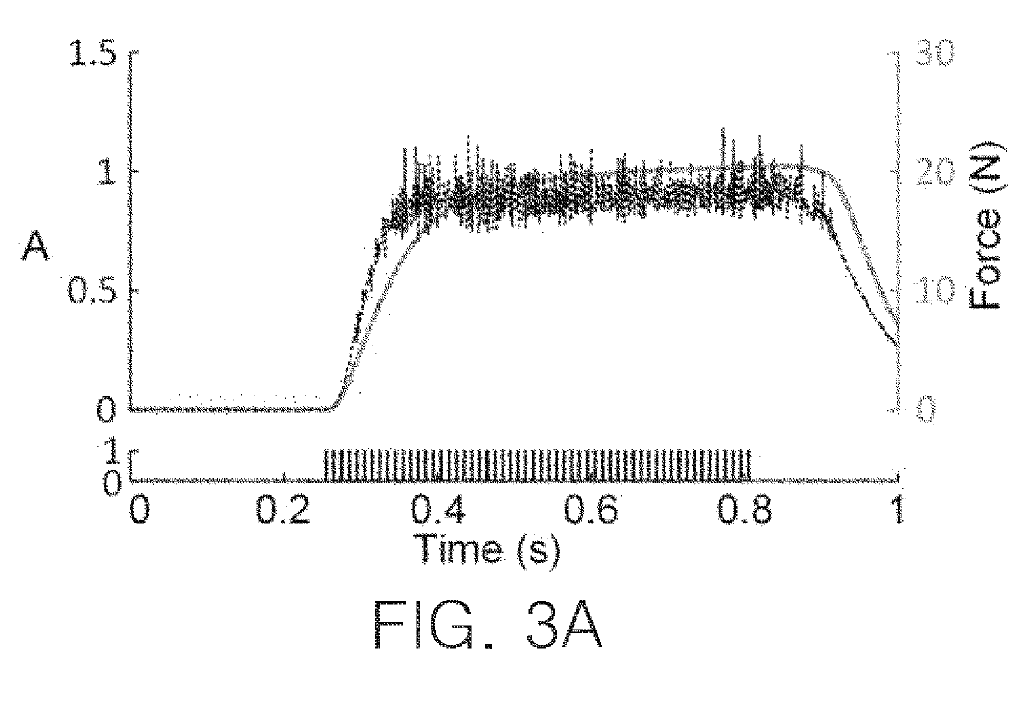

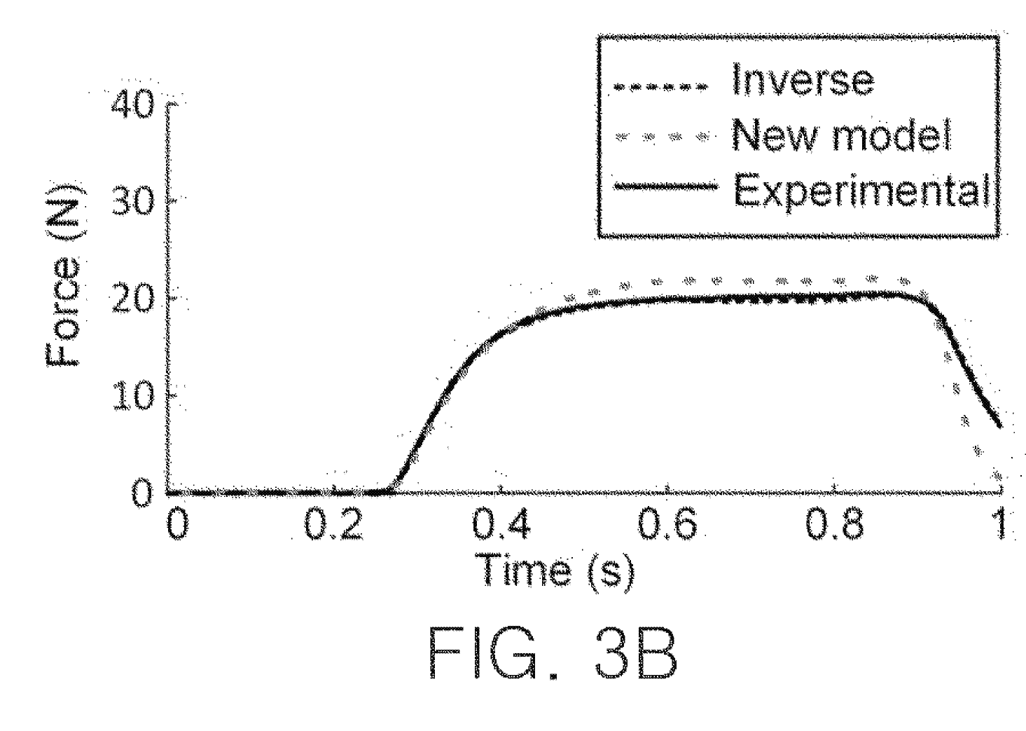

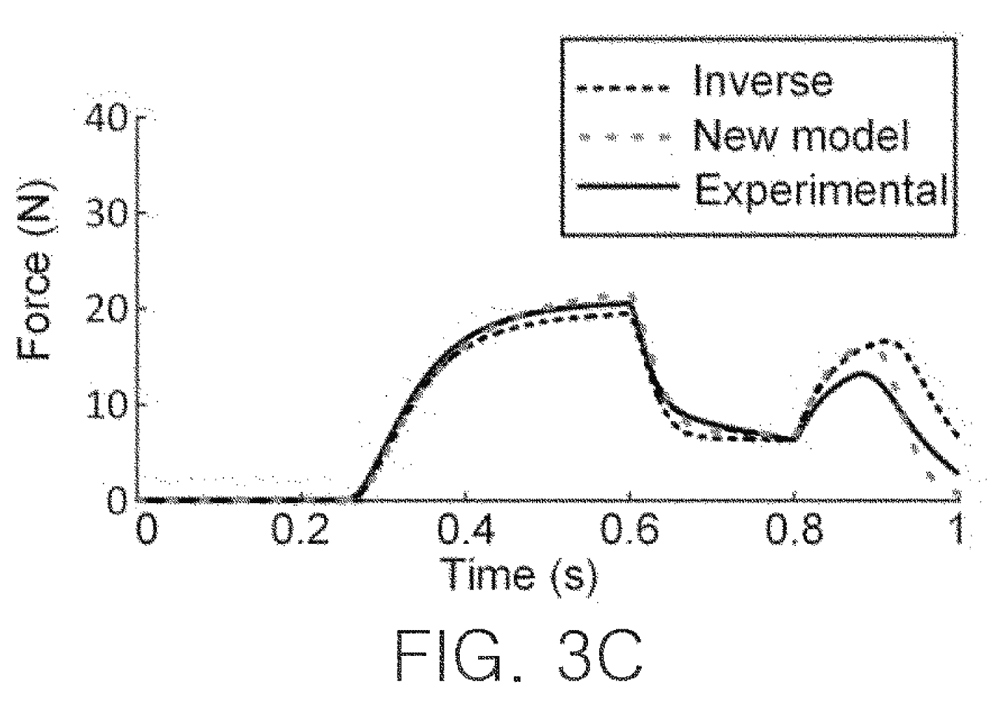

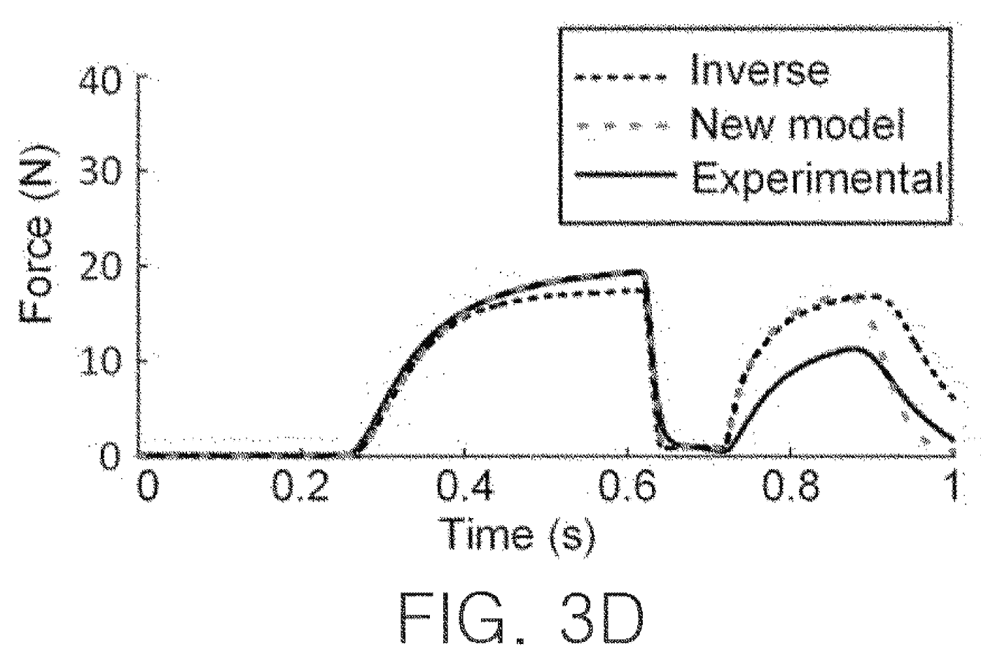

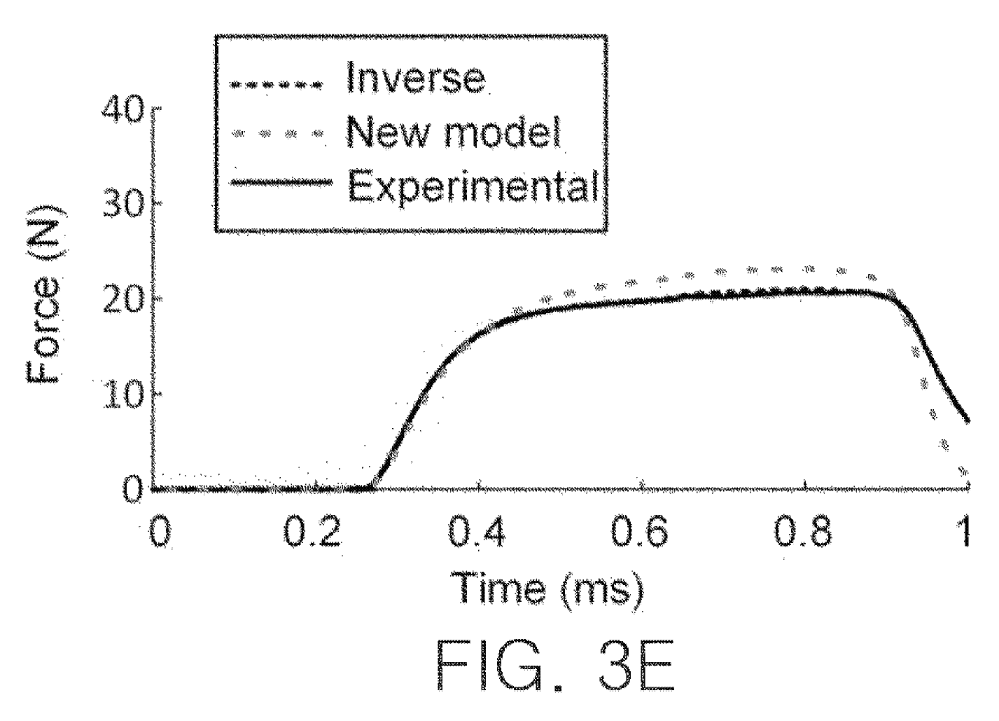

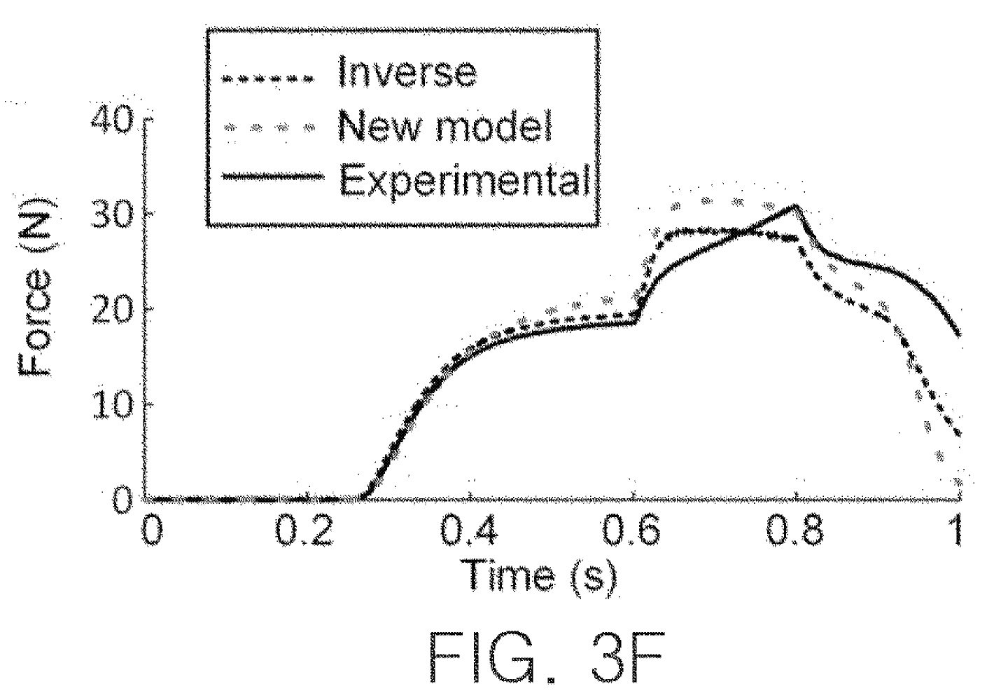

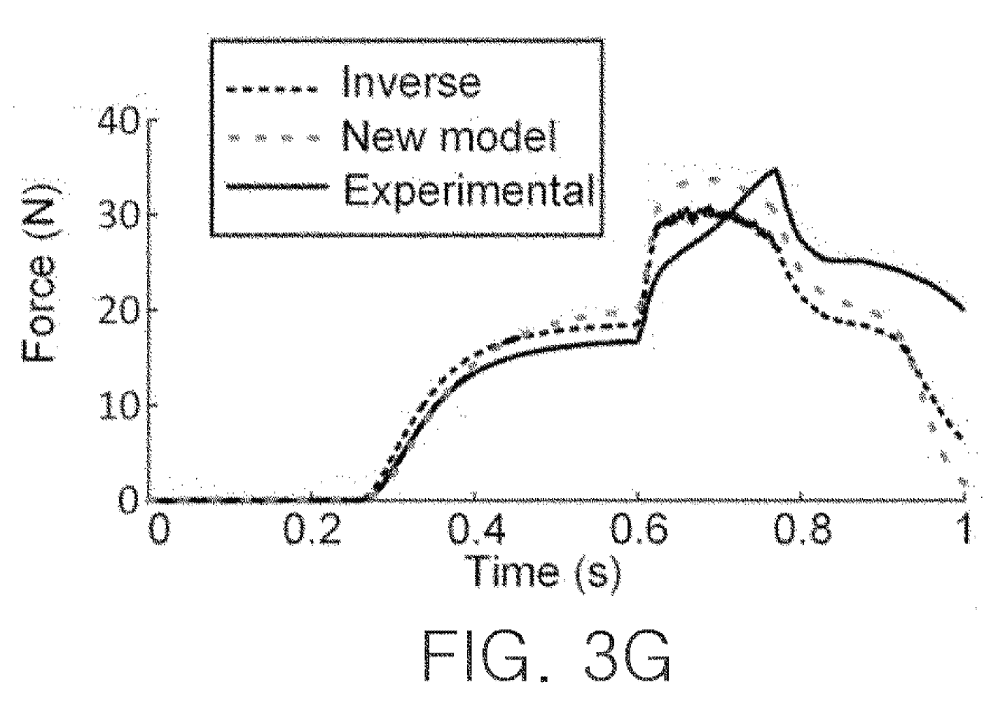

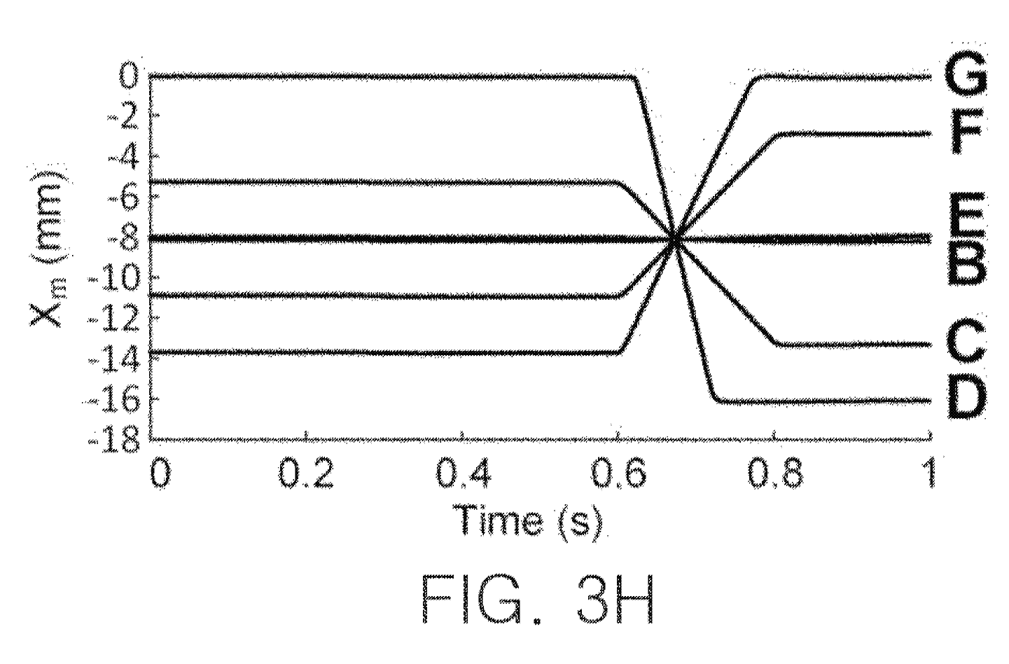

FIGS. 3A, 3B, 3C, 3D, 3F, 3G, and 3H show length- and velocity-tension properties under full excitation. In FIG. 3A, activation function (A, dotted black line) inversely calculated directly from the force data (gray line) measured at the optimal length (−8 mm) in response to 100 Hz impulse current (bottom). In FIGS. 3B-3G, time course of muscle forces driven by the inversely estimated (dotted black) and compensated (dotted red) activation function, and the real data (solid black) during isometric-isovelocity-isometric contractions. In FIG. 3H, profiles of muscle length (Xm) and velocity applied for FIGS. 3B-3G.

The compensated model for the length dependence (Eq. (20)) of the activation dynamics was then evaluated for the length-tension (L-T) and velocity-tension (V-T) property of the cat soleus muscle under fully excited state (100 Hz). To assess if the velocity influences the activation dynamics (A(t)), A(t) was inversely estimated from the tetanic response of the real muscle at the optimal length using Eq. (12)-(15) (FIG. 3A). Under the same input conditions, the force predicted based on the inversely estimated A(t) was compared to the real muscle and the model compensated in the isometric condition.

FIGS. 3B-3G show the comparison of muscle force between the inverse model (dotted black), compensated model (dotted red), and real muscle (solid black). As predicted in FIGS. 2A, 2B, 2C, 2D, 2E, and 2F, both inverse and compensated model well matched the time course of force development in the real muscle while sustaining muscle length at various levels. The agreement in the tetanic responses between two models implies that A(t) of the compensated model is similar to that of the inverse model. This result indicates that the calcium dynamics (modeled in Module in FIG. 1) of the compensated model may represent the physiological pattern of A(t) for isometric contraction with full excitation and confirms that the length dependency of A(t) tends to be weakened as the excitation frequency increases. During the isovelocity contraction, both inverse and new model also matched well the experimental data suggesting that A(t) is not be significantly affected by constant length change over time under full excitation.

However, the discrepancy between the simulated and real data occurred when the muscle force redeveloped in isometric condition after the end of isovelocity contraction. The simulation results by both methods were overestimated after shortening the muscle with constant velocity, whereas the simulation results were underestimated after the lengthening with constant velocity. In the present study, we did not consider this velocity dependent history effects on muscle force since its underlying mechanism is still unclear (see further discussion in the Discussion).

Force Production Under Dynamic Changes in Muscle Length and Excitation Frequency

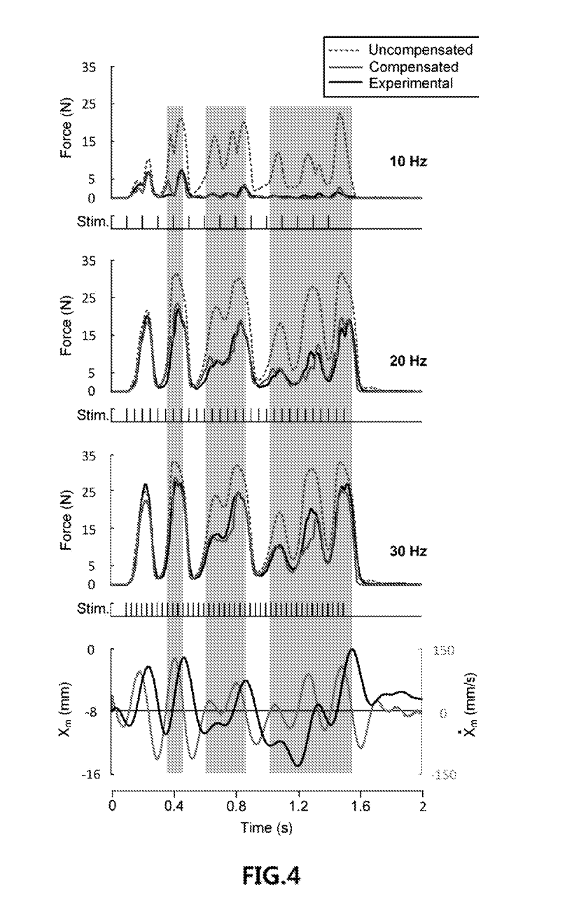

Having shown the length dependency of A(t) in static conditions (i.e. isometric and isovelocity), we evaluated if the compensation of the modified Hill model by Eq. (20) is sufficient to predict force production under dynamic input conditions. The excitation frequency varied from 10 to 30 Hz and the muscle length was randomly changed between −16 and 0 mm mimicking locomotion situation (bottom, FIG. 4).

FIG. 4 compares muscle force between the compensated model (dotted red) in the static condition and experimental data (solid black) from three levels (10, 20, and 30 Hz) of constant frequency during random variations in the length between −16 and 0 mm (bottom, FIG. 4). As previously reported (Elbasiouny et al 2005, Elbasiouny et al 2006, Powers et al 2012), the compensated model overestimated the force much more at physiologically relevant frequencies (<20 Hz) compared to higher level of excitation. Over these low frequencies, the slowly decreasing force output induced by the movement resulted in a prominent factor contributing to the simulation error. Because no molecular mechanism underlying this movement-induced force reduction has been reported, we arbitrarily compensated for this activation dependency by adding a mathematical term to the exponent (α) of Ã(t) so that the a gradually increases during movement,

$$A = {( \tilde{A} )}^{α ( t )} , α ( t ) = α + {α}_{1} \cdot ( 1 + tanh \frac{t - {α}_{2}}{{α}_{3}} ) \qquad ( 21 )$$

The three coefficients, α₁, α₂ and α₃ in Eq. (21), were adjusted using the NEURON optimization tool to best fit the data at all three levels of constant frequency during movement. Overall, sigmoidal increase of the level of a as a function of time (Eq. (21)) led to a dramatic reduction in simulation error at all levels of excitation frequency (FIG. 4).

In FIG. 4, muscle forces simulated by the compensated model (dotted red) for the length dependence of A(t) in the static condition (Eq. (20)) were compared to actual data (solid black) at three levels of excitation frequencies (10, 20, and 30 Hz) under the same profile of the dynamic change in muscle length (Xₘ, solid black) and velocity (\dot{X}ₘ, solid gray), as presented in the bottom panel. The vertical gray area indicates the range of the length and velocity over which the simulation error (the difference between dotted red and solid black lines) is the most intensified. The solid red lines represent the time course of the force production in the compensated model under static conditions after further compensating for the length and velocity dependence of A(t) during movement using Eq. (22).

The simulation error was also found to be intensified when the length was lower than the optimal length during positive (i.e., lengthening) velocity contraction (see the vertical gray areas in FIG. 4). To compensate for this length and velocity dependency of A(t) during movement with a minimum number of additional parameters, we further scaled the activation level by adding length and velocity dependence to Eq. (21) as mathematically modeled,

$$A = \frac{{( \tilde{A} )}^{α ( t )}}{( 1 + β \cdot ϕ ( {X}_{m} ) ) \cdot ( 1 + γ \cdot ( {V}_{m} ) )} \qquad ( 22 )$$

where φ(Xₘ) is the same function defined in Eq. (20) and Vₘ are the time derivative of Xₘ; β and γ were set to 0 for lengths longer than the optimal length or during the negative velocity movement.

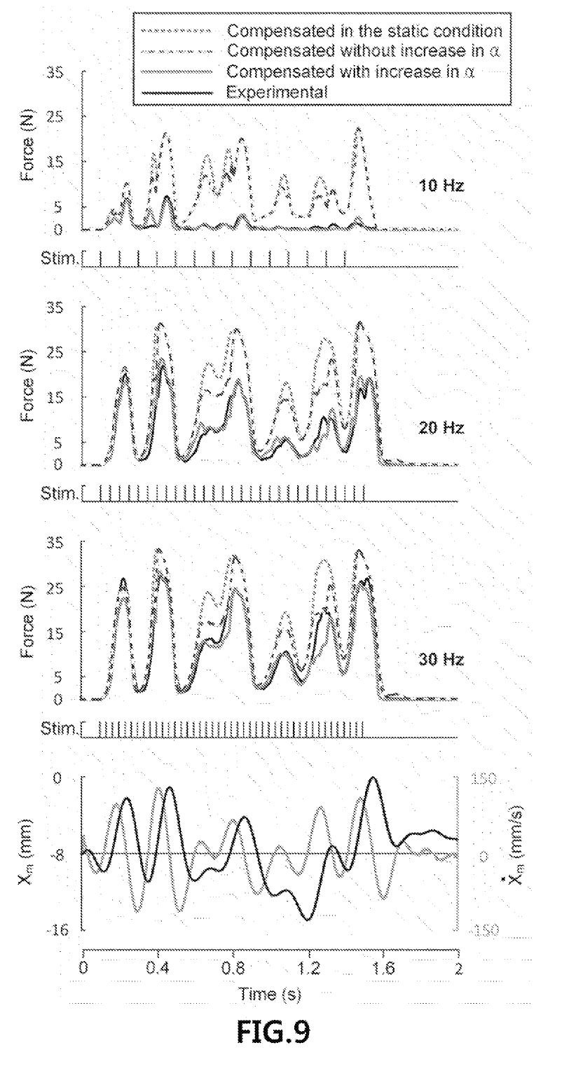

Consequently the addition of the length and velocity dependence (Eq. (22)) could effectively reduce the peak of simulation error that occurred at muscle lengths below the optimal length during lengthening movement (see FIG. 9 for relative contribution of α, β and γ on force development). All of these results reinforce the notion that the feedback of movement information into the activation dynamics is necessary for realistic simulations of Hill-type muscle models.

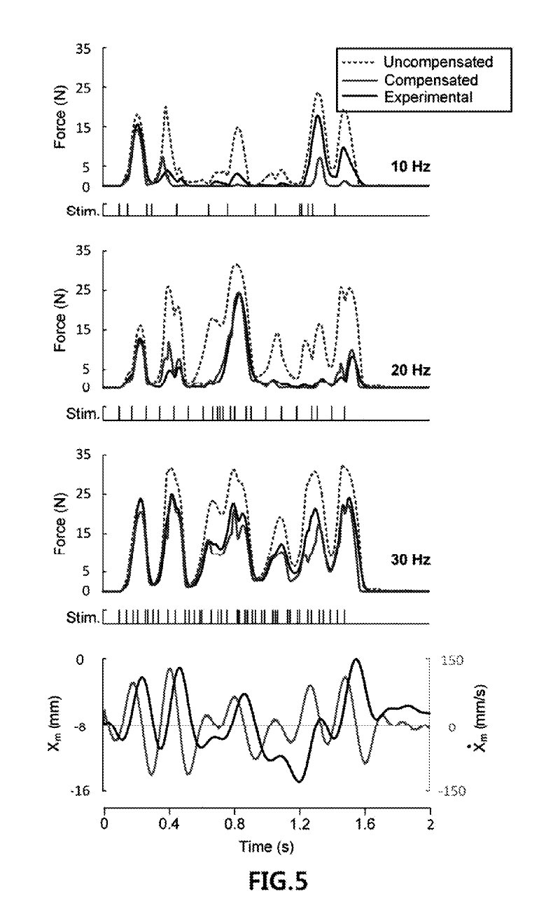

We further confirmed with more natural excitation that the model, compensated with Eq. (22), could predict the muscle force for random variation in the frequency with means of 10, 20, and 30 Hz (FIG. 5) during movement.

FIG. 5 shows force production during dynamic variations in muscle length and excitation frequency. Muscle forces produced by the compensated model under the static (dotted red) (Eq. (20)) and dynamic (solid red) conditions (Eq. (22)) were compared to actual data (solid black) with random variations in the excitation with mean frequencies (10, 20, and 30 Hz) and length (Xₘ, bottom panel) between 0 and −16 mm. The rate (\dot{X}ₘ) of length change is indicated as a solid gray line at the bottom panel.

In general, there was good agreement between the simulation results and experimental data. As observed in FIG. 4, the simulation error was more predominant for low frequencies 20 Hz) when the length was shorter than the optimal muscle length during lengthening.

Validation of the New Muscle Modeling Approach

To validate the modeling approach proposed in this study, a new set of default parameter values, with the exception of that for Module, were determined for data obtained from a different cat soleus muscle preparation (CT95) following the procedures presented in the Methods section (see FIGS. 7A, 7B, 7C, 7D, 7E, 7F, 7G, 7H, 7I, and 7J for the actual and simulated data), which are presented in Table 1.

All dependencies of A(t) identified in CT09 were consistently found for CT95. Thus, the same compensation mechanisms used for CT09 were applied to CT95. However, the degree of dependency of A(t) was much less in CT95. The variation in the peak of activation was negligible when muscle length was either shortened (−10 mm) or lengthened (0 mm) from the optimal length (−5 mm) in the isometric condition (FIG. 7J). Consequently the length dependency of A(t) during twitch and sub-tetanic contractions (Eq. 20) was captured by a single linear regression line with a shallow slope (0.006) for both shortening and lengthening to fit the three data points {(φ(Xₘ), Xₘ)|(0.97, −10), (1, −5), (1.03, 0)}.

The movement-induced force reduction at low frequencies (≦20 Hz), and length and velocity dependencies of A(t) during movement were compensated for by applying Eq. (22) with the same parameter values that used for CT09, except for α₁ and β. For CT95, α₁ and β must be lowered to 2 and 0.001 for best fit to the data indicating the less activation degradation and length dependency during movement compared to CT09.

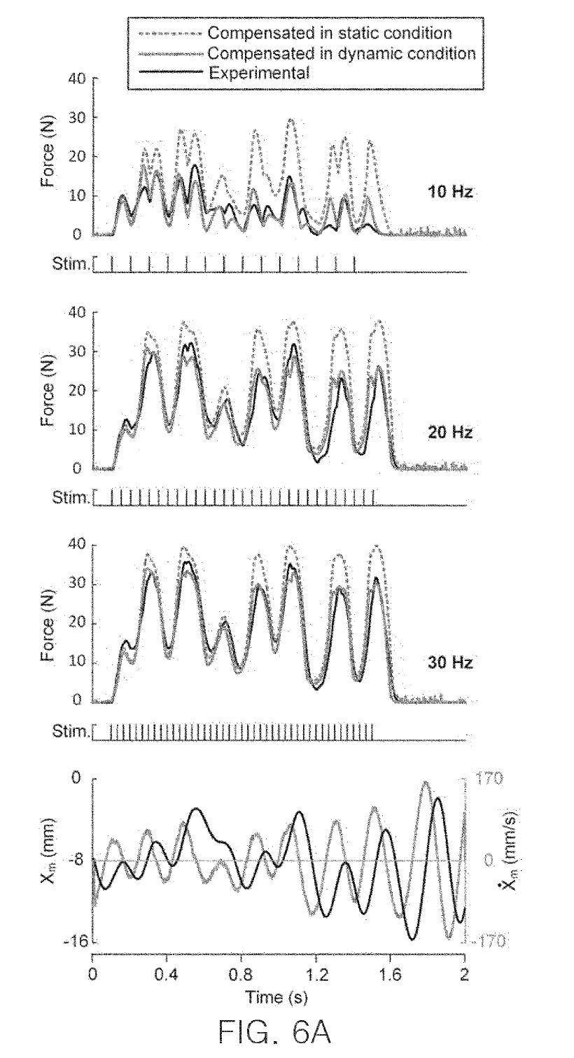

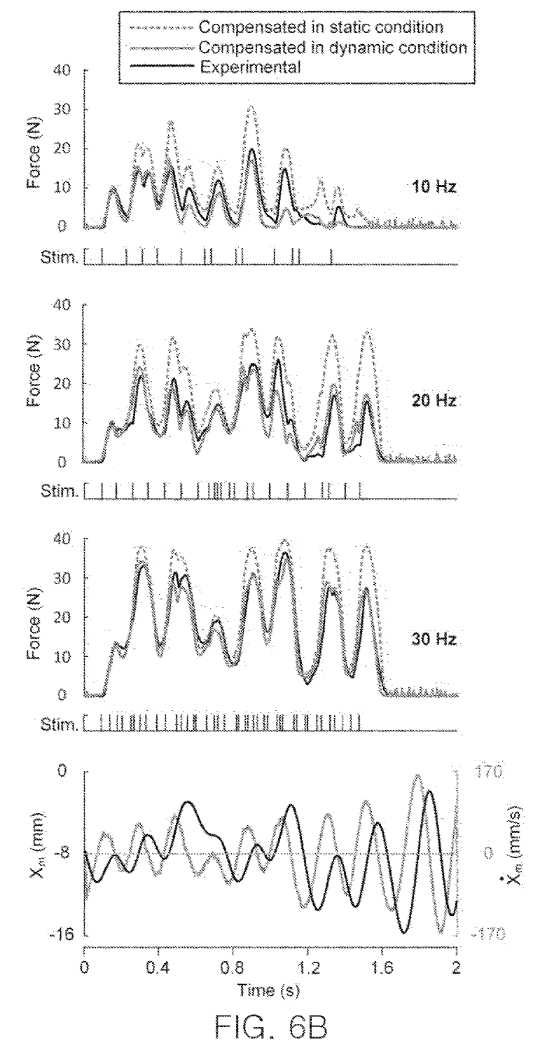

The muscle model for CT95 was tested against the actual muscle under the same dynamic conditions in which the length and frequency randomly varied, as shown in FIG. 5. In general, there was good agreement between the simulation results and actual data in either the constant (FIG. 6A) and random frequency during movement (FIG. 6B).

FIGS. 6A and 6B show force production during dynamic variations in length and frequency in CT95. The default parameter values of Modules and for CT09 were reset with the force data obtained from CT95 (see FIGS. 7A, 7B, 7C, 7D, 7E, 7F, 7G, 7H, 7I, and 7J for the data and Table 1 for the default parameter values). Muscle forces produced by the compensated model under the static (dotted red) and dynamic (solid red) conditions were compared to the actual data (solid black), with constant (right column) and random (left column) excitation frequencies (10, 20, and 30 Hz) under the same random variations in length (Xₘ) between 0 and −16 mm. The rate (\dot{X}ₘ) of length change is indicated as a solid gray line at the bottom panel.

This agreement suggests that the compensation mechanisms proposed for the dependencies of A(t) in this study may be applicable for accurate simulations of soleus muscles over a wide range of physiological conditions for the two inputs, muscle length and excitation frequency. However, it is notable that the degree of A(t) dependency on the static and dynamic contractions might vary between soleus muscles.

### Discussion

The inventor of the present invention has investigated the dependencies of the muscle activation dynamics (A(t)) on excitation and movement, and proposed the modified Hill-type muscle model that reproduces force production from the soleus muscles for the static and dynamic variation in two input signals (excitation frequency and muscle length). During dynamic change in muscle length, the suppression of A(t) during muscle movement below the optimal length along with movement-induced activation degradation was crucial for the prediction accuracy of the model. All these results emphasize that the influence of both static and dynamic length change on muscle activation should be considered for realistic simulations of the Hill-type muscle models under the physiological movement.

FIGS. 7A, 7B, 7C, 7D, 7E, 7F, 7G, 7H, 7I, and 7J show the default parameter values for the CT95 model. FIGS. 7A and 7B show time course (FIG. 7A) of muscle force in the isometric condition with full excitation during step shortening (FIG. 7B) of the muscle length (Xₘ) at 0.7 s. The K_{SE} in Module was calculated based on data from FIGS. 7A and 7B. FIGS. 7C to 7F show time courses (FIGS. 7C to 7E) of muscle force during three types of isometric-isokinetic-isometric contractions (FIG. 7F) with full excitation. Based on the length-tension and velocity-tension properties in FIGS. 7C to 7F, all parameter values of the Module \textcircled{3} except for K_{SE} were analytically determined using Eqs. (16)-(19). FIGS. 7C to 7J show twitches (FIG. 7J) at three different lengths and sub-tetanic responses (FIGS. 7G to 7I) at the optimal muscle length (−5 mm) with various frequencies. The parameter values (C1-C5) of Module were determined by fitting the FIGS. 7G to 7J data at the optimal length. The parameter values in Module were same as those used for CT09. See Table 1 for the default values for all model parameters.

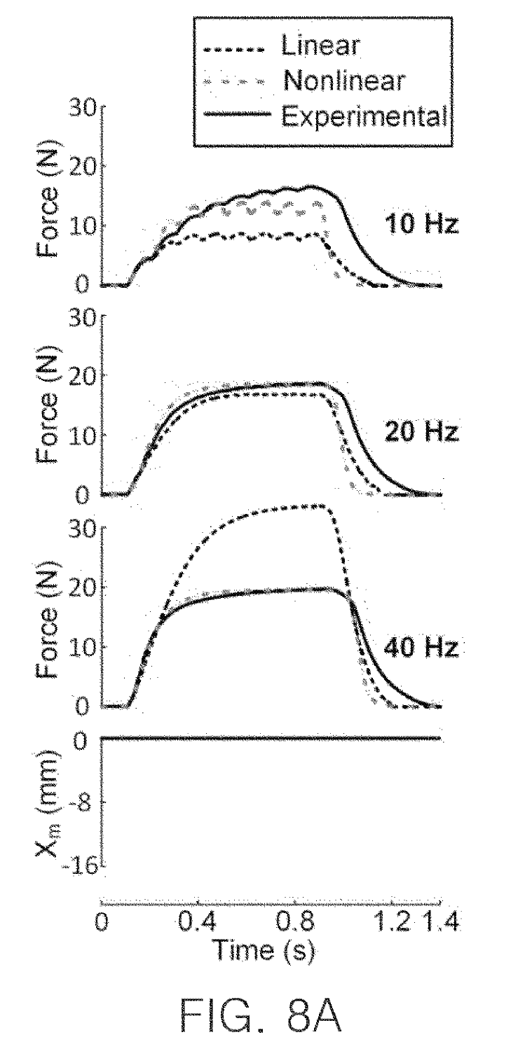

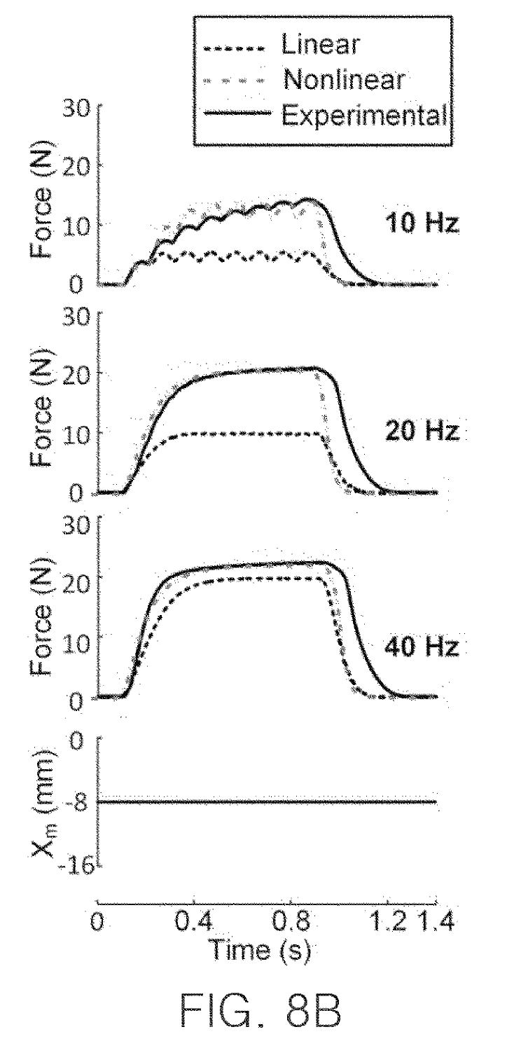

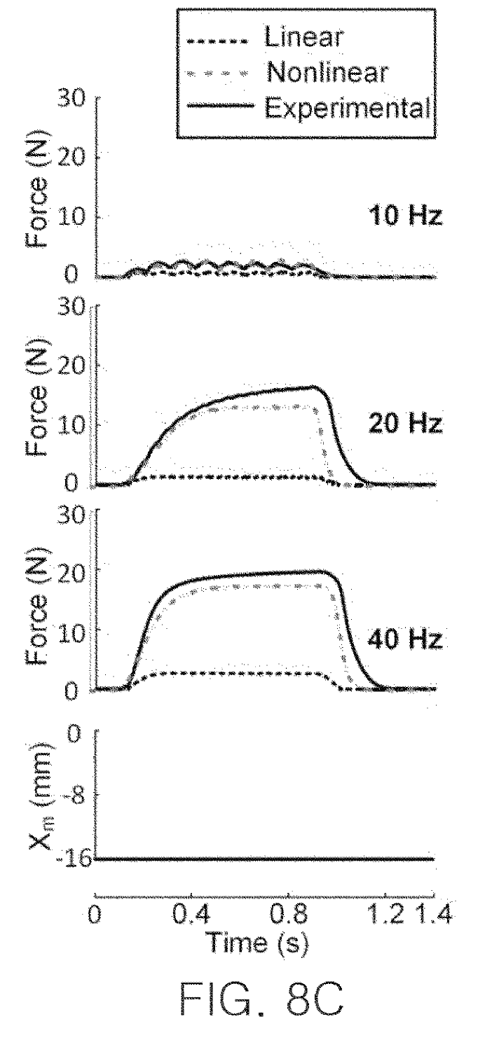

FIGS. 8A, 8B, 8C show influence of the nonlinear Ca-force relationship on sub-tetanic responses in the model. A model with a linear Ca-force relationship was simulated as a manner of estimating activation dynamics by linearly summing the activation function inversely predicted from the twitch response (FIGS. 2A to 2C) at various sub-tetanic frequencies (10, 20, and 40 Hz). In FIGS. 8A to 8C, At three different muscle lengths (Xₘ), i.e., 0 mm (FIG. 8A), −8 mm (FIG. 8B), and −16 mm (FIG. 8C), the sub-tetanic responses were compared between the linear (dotted black lines), nonlinear (dotted red lines), and actual (solid black lines) Ca-force relationship instances. The large simulation error in the linear model compared with experimental data indicate that the nonlinear relationship between the calcium concentration in the sarcoplasm and the muscle force must be reflected in the realistic simulations of the sub-tetanic responses in Hill-type models.

FIG. 9 shows effect of a increase on the sub-tetanic responses of the model during movement. The dotted and solid red lines represent the simulated forces using the model compensating for the A(t) length dependency under the static condition and the same model further compensating for the length and velocity dependencies under the dynamic condition, respectively. The solid blue lines indicate the forces simulated using the model compensating for all identified dependencies of A(t) under the static and dynamic conditions without increasing a value from its default value. Note the dramatic reduction in the simulation error between the model without and with a increase compared with the actual data (solid black lines), particularly over low frequencies (≦20 Hz). This result suggests that movement-induced activation degradation may be a dominant factor determining force production during movement in a physiologically relevant excitation frequency range.

Comparison with Previous Studies

In the previous studies, the dynamics of muscle activation has been investigated under limited conditions in excitation frequency and muscle length. The dependence of A(t) on the frequency and the length has been evaluated and modeled for static (i.e., isometric and isokinetic) contractions at various frequencies (Brown et al 1999, Brown et al 1996). In other hand, the movement dependency of A(t) has been characterized and formulated under tetanic or tetanic-like excitation (Shue and Crago 1998, Williams et al 1998). In the present invention, we have evaluated and identified the frequency and length dependencies of A(t) while systematically varying the frequency (twitch to tetanic) and the length (isometric to locomotor-like movement) over the full physiological range. What we have found critical from the present analysis is that the phenomenon of movement-induced activation degradation at the low frequencies should be taken into account for realistic modeling of A(t) during movement (FIG. 9).

A modular framework has been applied to model the activation dynamics based on three signal transductions (i.e., neural excitation→Ca_{SP}→A(t)→muscle force) during force production (Williams et al 1998, Laforet et al 2011). In previous modeling approaches, all model parameters have been optimized to match the overall input-output properties of target muscles under limited conditions, such as sinusoidal movement or full excitation. The simultaneous adjustment of all model parameters may give rise to several numerical issues related to optimization time, parameter redundancy, and stability because the number of parameters typically increases with increases in the complexity of input conditions and muscle responses. To avoid these issues while increasing computational tractability, we have determined the model parameter values separately for individual modules directly based on relevant data.

The muscle models have been implemented in the software environment that is not in favor of building and simulating realistic motor neuron models. In the present invention, the features of our modular modeling approach proved to be useful for the implementation in NEURON software environment, which supports compartmental modeling, addition of new biophysical mechanisms, and independent manipulation of inserted mechanisms for multi-purpose simulations. To our knowledge, we are the first to demonstrate the possibility of incorporating mechanical mechanisms into NEURON platform. Our muscle modeling approach implementable in general neuron simulators will be particularly convenient for studies coupling output of models of spinal motoneurons (e.g., (Carlin et al 2000, Elbasiouny et al 2006, Kim et al 2014)) to muscle fibers.

The transduction of Ca_{SP} to A(t) has been captured by modeling the chemical reactions between actin and myosin molecules in either a simplified (Backx et al 1995) or detailed form (Stephenson and Wendt 1984). In previous studies, all model parameters were simultaneously optimized to fit the overall input-output properties. Thus, it has been uncertain whether previous models could capture the cooperative effects of Ca on force production that have been characterized by the nonlinear (i.e., logistic) relationship between Ca_{SP} and Force in both computational (Millard et al 2013, Sandercock and Heckman 1997b, Perreault et al 2003) and experimental (Shue and Crago 1998) studies. In the present invention, the Ca_{SP}-force relationship was dynamically represented in Module using the Morris-Lecar formulation, and its five parameters (C1-C5 in Eq. (11)) were adjusted to match the twitch and sub-tetani of actual muscle at an optimal length. As a result, the sigmoid shape of the Ca_{SP}-to-force relationship in the steady state (see the Ã_{∞}-Ca_{SP}T curve in Module, FIG. 1) and the slow kinetics of the activation dynamics (see τ₄ in Module, FIG. 1) in our model were consistent with those reported in previous studies. In addition, the τ_{Ã} did not significantly vary over a wide range of Ca_{SP}T, suggesting that the dynamics of the Ca_{SP}-to-force transduction might be described with only two parameters (C1 and C2) for the Ã_{∞}-Ca_{SP}T relationship under the assumption of a constant time constant. Furthermore, to determine whether the nonlinear shape of the Ca_{SP}-to-force relationship was important, we compared this case with the linear relationship of the Ca_{SP} to force. The comparison results indicated that the model with a linear relationship resulted in significant simulation errors during the sub-tetanic responses of the cat soleus muscle over a physiologically relevant frequency range (Fig. S2). These results indicate that the nonlinear relationship between the Ca_{SP} and force should be reflected in accurate simulations of muscle responses for a wide range of input conditions.

In the present invention, the dependencies of A(t) were investigated for slow (i.e. soleus) muscles of cats. During isometric contractions, the amplitude of A(t) was more sensitive to the shortening relative to the lengthening (FIG. 2D-2F). In addition, the length dependency of A(t) was prominent at low rather than high level of excitation frequency (FIG. 2A-2C). These findings are similar to those reported in the previous studies for fast (i.e. caudofemoralis) muscles of cats (Brown and Loeb 1999). This result suggests that the length and frequency dependency of A(t) in isometric conditions seem to be a generic feature, not type specific.

For tetanic muscle behavior, the post-activation potentiation (PAP) after activities has been experimentally shown in fast muscles of cats and reported to make rise and fall times of tetanic response faster and slower respectively when potentiated (Brown and Loeb 1999). In the present invention, we also found the PAP like behavior in one (i.e. CT09) of slow muscles for twitch and tetanic contractions when compared to the model not considering the PAP phenomenon (FIGS. 2B and 2C, see FIG. 9 in Shue and Crago). However, this result was not obvious in the other muscle preparation (i.e. CT95) (see Fig. S1). Thus, further works would be needed to clarify if and how the PAP affects force production of slow muscles.

The length dependency of contractile activation has been shown to be related to the decrease in the contractile protein sensitivity to Ca²⁺ at shortened lengths, leading to degradation of the activation level (Gillard et al 2000). As predicted from this experimental observation, the default model without length-dependent compensations significantly overestimated activation dynamics when the length was shortened below the optimal length (see FIG. 2F). This shortening-induced activation degradation was reflected by making a single rate constant (K5 in FIG. 1) for the Ca²⁺-troponin reaction as a function of length. As a result, the compensated model with K5 modulated according to the length change matched the rising phase of the force development well during twitch and sub-tetanic contractions. However, this compensation via K5 modulation was not sufficient to reproduce the relaxation dynamics of muscles after the end of excitation (e.g., PAP like phenomenon, FIGS. 2A, 2B, 2C, 2D, 2E, and 2F). This result suggests that many factors, including passive filament components (e.g., titin), might be simultaneously involved in determining activation dynamics during the relaxation phase of muscle contraction. Further studies are needed to determine the details of molecular mechanisms underlying this post-activation potentiation.

Error in the Hill-type muscle model has been reported to be prominent during muscle movement (McGowan et al 2010, De Ruiter et al 1998). In the present invention, we further demonstrated that model error could also be significant at physiologically relevant frequencies even during isometric contractions (FIG. 2E). The error found between the model and actual muscle during movement was attributed in part to the hyperactivation of the models at lengths shorter than the optimization length (FIG. 4), which is similar to the results obtained for isometric contractions (FIGS. 2A, 2B, 2C, 2D, 2E, and 2F). The model error associated with hyperactivation during movement was compensated for based on the formulation consisting of muscle length and velocity, as suggested for a slow change in muscle length and wide width of pulse stimulation in the previous study (Shue and Crago 1998). However, in our case, in which the muscle moved in a relatively fast mode with impulse excitation, muscle length had a more dominant effect on activation dynamics compared with velocity. In fact, the influence of velocity on activation dynamics was almost negligible in our model (see the value of γ=0.001 in Eq. (22)). The movement-induced force depression (Fuchs and Martyn 2005) was relatively more significant during movement under low frequencies (see the top panel in Fig. S3). Because the molecular mechanisms underlying this movement-induced force depression remain unclear, we compensated for this model error by gradually increasing a in Module to give rise to a slow reduction in the activation level during movement (Fig. S3). However, the similar movement induced effect on force depression was also possibly obtained by changing other factors including K1, K2, Rₘₐₓ, K5 and K6i from their initial values. All of these results suggest that muscle length and movement-induced activation degradation are prominent factors influencing the activation dynamics of cat soleus muscles during movement.

Direct comparison of the compensation mechanisms for dependencies in the activation dynamics between this and previous studies is difficult due to differences in the input conditions and species in which individual studies have been interested. In the present invention, we focused on force production in adult cat soleus muscles over a wide range of input conditions for excitation frequency (1 to 100 Hz) and length change (e.g., isometric, isokinetic, and dynamic). Furthermore, the present invention is the first to demonstrate the applicability of Hill-type models for a full physiological range of excitation frequency and muscle length in mammals. The Hill-type muscle model has been ubiquitously employed in many large-scale simulations mainly for the bio-mechanical analysis of motor performance in human and animals (Biewener et al 2014). Our modified Hill-type muscle model would make significant contribution to not only improving the reliability of musculoskeletal simulations of movement, but also extending the usage of these simulations to the study of neural mechanisms underlying movement control.

### CONCLUSION

There has been a need for a spike-driven model of the activation dynamics in many neuromuscular simulations using the Hill-type muscle models. The activation model developed in the current study allows not only muscle behavior simulation under a physiologically-relevant neural excitation and muscle movement, but also efficient implementation in the neuron simulators where neuron models are generally reconstructed. We hope that the new Hill-type muscle model could enhance the accuracy of large-scale neuromuscular simulations and thus contribute to advancing our understanding of the neural control of muscle force to cause proper motion.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

1. Modeling system for muscle cell activation, comprising:
a first module transforming electrical signals from motoneurons to concentration of Ca²⁺ in the sarcoplasm;
a second module receiving the concentration of Ca²⁺ from the first module and transforming the concentration of Ca²⁺ to and activation dynamics of muscle; and
a third module receiving the activation dynamics of muscle from the second module and transforming the activation dynamics of muscle to muscle force,
wherein the first module and the second module compensate a length dependency of the concentration of Ca²⁺ and the activation dynamics.

2. The modeling system as set forth in claim 1, wherein the first module comprises modeling of two compartments which consist of sarcoplasmic reticulum (SR) and sarcoplasm (SP).

3. The modeling system as set forth in claim 2, wherein the first module transforms the electrical signals from the motoneurons to the concentration of Ca²⁺ based on the sarcoplasmic reticulum (SR) model, the sarcoplasm (SP) model and cooperativity of chemical activation, as following equations (1) to (10):
ĆS=−K1·CS·Ca_{SR}+K2·Ca_{SR}CS (1);
Cá_{SR}=−K1·CS·Ca_{SR}+K2·Ca_{SR}CS−R+U (2);
Ca_{ŚR}CS=K1·CS·Ca_{SR}−K2·Ca_{SR}CS (3);
$$\begin{matrix}R = {Ca}_{SR} \cdot {P}_{max} \cdot ( 1 - exp \frac{- t}{{τ}_{1}} ) \cdot exp \frac{- t}{{τ}_{2}} ; & ( 4 ) \\ U = {U}_{max} \cdot {( \frac{{{Ca}_{SR}^{ }}^{2} \cdot {K}^{2}}{1 + {Ca}_{SR} \cdot K + {{Ca}_{SR}^{ }}^{2} \cdot {K}^{2}} )}^{2} ; & ( 5 )\end{matrix}$$
\acute{B}=−K3·Ca_{SP}·B+K4·Ca_{SP}B (6);
Cá_{SP}=−K5·Ca_{SP}·T+K6·Ca_{SP}T−K3·Ca_{SP}·B+K4·Ca_{SP}B+R−U (7);
\acute{T}=−K5·Ca_{SP}·T+K6·Ca_{SP}T (8);
Ca_{ŚP}·B=K3·Ca_{SP}·B−K4·Ca_{SP}B (9);
Ca_{ŚP}T=K5·Ca_{SP}·T−K6·Ca_{SP}T (10),
(Ca_{SR}: the Ca2+ concentration in the SR, Ca_{SP}: the Ca2+ concentration in the SP, CS: calsequestrin), R: flux of Ca2+ release from the SR, U: flux of Ca2+ reuptake to the SR, K1 and K2: two rate constants that govern chemical reaction between free calcium ions and calsequestrin, Pₘₐₓ: maximum permeability of SR, τ₁ and τ₂: time constant of increase and decrease in permeability, Uₘₐₓ: maximal pump rate, K: site binding constant for Ca2+ to activate the pump in the sarcoplasmic reticulum, B: free buffer substances in thin filaments while interacting with SR via R and U, T: troponin in the thin filaments while interacting with SR via R and U, K3 and K4: forward and backward rate constants between Ca2+ and Ca2+-binding buffers (Ca_{SP}B), K5 and K6: forward and backward rate constants between Ca2+ and Ca2+-binding troponin (Ca_{SP}T), K6: a function of the muscle activation (A), K6=K6ᵢ/(1+5·A) where K6ᵢ, is an initial rate constant.)

4. The modeling system as set forth in claim 1, wherein the second module represents a steady-staterelationship between Ca and force mapped to Ca2+-binding troponin (Ca_{SP}T) and activation level (Ã) as following equation 11:
$$\dot{\tilde{A}} = \frac{{\tilde{A}}_{∞} - \tilde{A}}{{τ}_{\tilde{A}}} \\ where \\ {\tilde{A}}_{∞} = 0.5 \cdot ( 1 + tanh \frac{{Ca}_{SP} T / ( {Ca}_{SP} T + T ) - C 1}{C 2} ) , \\ {τ}_{\tilde{A}} = C 3 \cdot {( cosh \frac{{Ca}_{SP} T / ( {Ca}_{SP} T + T ) - C 4}{2 \cdot C 5} )}^{- 1} , \qquad ( 11 )$$
Ã_{∞} is the steady-state value of Ã at the normalized Ca_{SP}T relative to the total troponin concentration in the SP, τ_{Ã} is a time constant controlling speed at which the individual values of Ã_{∞} are approached, C1 is the normalized Ca_{SP}T for half muscle activation, C2 is a slope of activation curve at C1, C3 is a scaling factor for temperature, C4 is the normalized Ca_{SP}T for maximum time constant, and C5 determines width of the bell-shaped τ_{Ã} curve.

5. The modeling system as set forth in claim 4, wherein the second module updates the Ã(t) to the A(t) in exponential form as (Ã)^{α} with an exponent α assuming the reduction in likelihood of cross-bridge formation under impulse stimulation relative to the steady case for the transient Ca_{SP} variation during electrical excitation.

6. The modeling system as set forth in claim 1, wherein the third module transforms the activation dynamics to the muscle force based on the simplest form of Hill-based muscle models that consists of contractile and serial elastic element in series as following equation (12)-(15):
F=P₀·K_{SE}·(ΔXₘ−ΔX_{CE}) (12)
$$\begin{matrix}{X}_{CE}^{*} = \frac{- {b}_{0} \cdot ( {P}_{0} \cdot g ( {X}_{m} ) \cdot A ( t ) - F )}{F + {a}_{0} \cdot g ( {X}_{m} ) \cdot A ( t )} for F \leq {P}_{0} \cdot g ( {X}_{m} ) \cdot A ( t ) & ( 13 ) \\ {X}_{CE}^{*} = \frac{- {d}_{0} \cdot ( {P}_{0} \cdot g ( {X}_{m} ) \cdot A ( t ) - P )}{2 {P}_{0} \cdot g ( {X}_{m} ) \cdot A ( t ) - P + {c}_{0} \cdot g ( {X}_{m} ) \cdot A ( t )} \\ for P > {P}_{0} \cdot g ( {X}_{m} ) \cdot A ( t ) & ( 14 ) \\ g ( {X}_{m} ) = exp \{ - {( \frac{{X}_{m} - {g}_{1}}{{g}_{3}} )}^{2} \} & ( 15 )\end{matrix}$$
where P₀ is the maximum muscle force at optimal muscle length, K_{SE} is the stiffness of the serial elastic element normalized with P₀, a₀, b₀, c₀ and d₀ are Hill-Mashma equation coefficients, g(Xₘ) is function of length-tension relation of muscle as a Gaussian function normalized with the P₀, g1-g2 are Gaussian coefficients indicating scaling factor, optimal muscle length and range of muscle length change, respectively.

7. The modeling system as set forth in claim 6, wherein a₀, b₀, c₀ and d₀ in the equations 14 and 15 are analytically determined based on length-tension (L-T) and velocity-tension (V-T) property by deriving inverse equations for the four coefficients given four data points ((V_{S,1}, T_{S,1}), (V_{S,2}, T_{S,2}), (V_{L,1}, T_{L,1}), (V_{L,2}, T_{L,2})) on V-T curve where V_{S,1} and V_{S,2} are minimum and maximum shortening velocities, and V_{L,1} and V_{L,2} are minimum and maximum lengthening velocities as following equations 16 to 19:
$$\begin{matrix}{a}_{0} = \frac{{V}_{S , 1} \cdot {T}_{S , 1} \cdot ( {P}_{0} - {T}_{S , 2} ) - {V}_{S , 2} \cdot {T}_{S , 2} \cdot ( {P}_{0} - {T}_{S , 1} )}{{V}_{S , 2} \cdot ( {P}_{0} - {T}_{S , 1} ) - {V}_{S , 1} \cdot ( {P}_{0} - {T}_{S , 2} )} & ( 16 ) \\ {b}_{0} = \frac{{V}_{S , 2} \cdot {V}_{S , 1} \cdot ( {T}_{S , 1} - {T}_{S , 2} )}{{V}_{S , 1} \cdot ( {P}_{0} - {T}_{S , 2} ) - {V}_{S , 2} \cdot ( {P}_{0} - {T}_{S , 1} )} & ( 17 ) \\ {c}_{0} = \frac{\begin{matrix}( 2 \cdot {V}_{L , 2} \cdot {P}_{0} - {V}_{L , 2} \cdot {T}_{L , 2} ) \cdot ( {P}_{0} - {T}_{L , 1} ) + \\ ( {V}_{L , 1} - {T}_{L , 1} - 2 \cdot {V}_{L , 1} \cdot {P}_{0} ) \cdot ( {P}_{0} - {T}_{L , 2} )\end{matrix}}{{V}_{L , 1} \cdot \{ {P}_{0} - {T}_{L , 2} - {V}_{L , 2} \cdot ( {P}_{0} - {T}_{L , 1} ) \}} & ( 18 ) \\ {d}_{0} = \frac{{V}_{L , 1} \cdot {V}_{L , 2} \cdot ( {T}_{L , 1} - {T}_{L , 2} )}{{V}_{L , 2} \cdot ( {P}_{0} - {T}_{L , 1} ) - {V}_{L , 1} \cdot ( {P}_{0} - {T}_{L , 2} )} . & ( 19 )\end{matrix}$$

8. The modeling system as set forth in claim 3, wherein a dependence of the activation dynamics on the muscle length during isometric and isokinetic contractions is compensated by making the rate constant (K5) of the Ca2+-troponin reaction a function of the muscle length (Xm) as following equation 20,
$$K {5}^{*} = ϕ ( {X}_{m} ) \cdot K 5 , \{ \begin{matrix}ϕ ( {X}_{m} ) = {ϕ}_{1} \cdot {X}_{m} + {ϕ}_{2} for {X}_{m} < optimal lengt • \\ ϕ ( {X}_{m} ) = {ϕ}_{3} \cdot {X}_{m} + {ϕ}_{4} for {X}_{m} \geq optimal length\end{matrix} \qquad ( 20 )$$
where φ₀-φ₄ is determined using a curve fit tool built in Matlab for the data set (φ(Xₘ), Xₘ).

9. The modeling system as set forth in claim 8, wherein the dependence of the activation dynamics on dynamic movement is compensated by adding a mathematical term to the exponent (α) of Ã(t) so that the α gradually increases during movement as following equation 21,
$$A = {( \tilde{A} )}^{α ( t )} , α ( t ) = α + {α}_{1} \cdot ( 1 + tanh \frac{t - {α}_{2}}{{α}_{3}} ) \qquad ( 21 )$$
where α₁, α₂ and α₃ is adjusted using the NEURON optimization tool to best fit the data at all three levels of constant frequency during movement.

10. The modeling system as set forth in claim 8,
wherein the dependence of the activation dynamics on the muscle length and velocity during the dynamic movement is compensated as following equation 22,
$$A = \frac{{( \tilde{A} )}^{α ( t )}}{( 1 + β \cdot ϕ ( {X}_{m} ) ) \cdot ( 1 + γ \cdot ( {V}_{m} ) )} \\ where \\ α ( t ) = α + {α}_{1} \cdot ( 1 + tanh \frac{t - {α}_{2}}{{α}_{3}} ) , \qquad ( 22 )$$
α₁, α₂ and α₃ is adjusted using the NEURON optimization tool to best fit the data at all three levels of constant frequency during movement, φ(Xₘ) is the same function defined in equation 20, Vₘ are the time derivative of Xₘ, and β and γ were set to 0 for lengths longer than the optimal length or during negative velocity movement.

11. Modeling method for muscle cell activation, comprising:
a first step transforming electrical signals from motoneurons to concentration of Ca²⁺ in the sarcoplasm;
a second step receiving the concentration of Ca²⁺ from the first step and transforming the concentration of Ca²⁺ to and activation dynamics of muscle; and
a third step receiving the activation dynamics of muscle from the second step and transforming the activation dynamics of muscle to muscle force,
wherein the first step and the second step compensate a length dependency of the concentration of Ca²⁺ and the activation dynamics.

12. The modeling method as set forth in claim 11, wherein the first step comprises modeling of two compartments which consist of sarcoplasmic reticulum (SR) and sarcoplasm (SP).

13. The modeling method as set forth in claim 12, wherein the first step transforms the electrical signals from the motoneurons to the concentration of Ca²⁺ based on the sarcoplasmic reticulum (SR) model, the sarcoplasm (SP) model and cooperativity of chemical activation, as following equations (1) to (10):
ĆS=−K1·CS·Ca_{SR}+K2·Ca_{SR}CS (1);
Cá_{SR}=−K1·CS·Ca_{SR}+K2·Ca_{SR}CS−R+U (2);
Ca_{ŚR}CS=K1·CS·Ca_{SR}−K2·Ca_{SR}CS (3);
$$\begin{matrix}R = {Ca}_{SR} \cdot {P}_{max} \cdot ( 1 - exp \frac{- t}{{τ}_{1}} ) \cdot exp \frac{- t}{{τ}_{2}} ; & ( 4 ) \\ U = {U}_{max} \cdot {( \frac{{{Ca}_{SR}^{ }}^{2} \cdot {K}^{2}}{1 + {Ca}_{SR} \cdot K + {{Ca}_{SR}^{ }}^{2} \cdot {K}^{2}} )}^{2} ; & ( 5 )\end{matrix}$$
\acute{B}=−K3·Ca_{SP}·B+K4·Ca_{SP}B (6);
Cá_{SP}=−K5·Ca_{SP}·T+K6·Ca_{SP}T−K3·Ca_{SP}·B+K4·Ca_{SP}B+R−U (7);
\acute{T}=−K5·Ca_{SP}·T+K6·Ca_{SP}T (8)
Ca_{ŚP}·B=K3·Ca_{SP}·B−K4·Ca_{SP}B (9);
Ca_{ŚP}T=K5·Ca_{SP}·T−K6·Ca_{SP}T (10),
(Ca_{sR}: the Ca2+ concentration in the SR, Ca_{SP}: the Ca2+ concentration in the SP, CS: calsequestrin), R: flux of Ca2+ release from the SR, U: flux of Ca2+ reuptake to the SR, K1 and K2: two rate constants that govern chemical reaction between free calcium ions and calsequestrin, Pₘₐₓ: maximum permeability of SR, τ₁, and τ₂: time constant of increase and decrease in permeability, Uₘₐₓ: maximal pump rate, K: site binding constant for Ca2+ to activate the pump in the sarcoplasmic reticulum, B: free buffer substances in thin filaments while interacting with SR via R and U, T: troponin in the thin filaments while interacting with SR via R and U, K3 and K4: forward and backward rate constants between Ca2+ and Ca2+-binding buffers (Ca_{SP}B), K5 and K6: forward and backward rate constants between Ca2+ and Ca2+-binding troponin (Ca_{SP}T), K6: a function of the muscle activation (A), K6=K6ᵢ/(1+5·A) where K6ᵢ is an initial rate constant.)

14. The modeling system as set forth in claim 11, wherein the second step represents a steady-state relationship between Ca and force mapped Ca2+-binding troponin (Ca_{SP}T) and activation level (Ã) as following equation 11:
$$\dot{\tilde{A}} = \frac{{\tilde{A}}_{∞} - \tilde{A}}{{τ}_{\tilde{A}}} \\ where \\ {\tilde{A}}_{∞} = 0.5 \cdot ( 1 + tanh \frac{{Ca}_{SP} T / ( {Ca}_{SP} T + T ) - C 1}{C 2} ) , \\ {τ}_{\tilde{A}} = C 3 \cdot {( cosh \frac{{Ca}_{SP} T / ( {Ca}_{SP} T + T ) - C 4}{2 \cdot C 5} )}^{- 1} , \qquad ( 11 )$$
Ã_{∞} is the steady-state value of Ã at the normalized Ca_{SP}T relative to the total troponin concentration in the SP, τ_{Ã} is a time constant controlling speed at which the individual values of Ã_{∞} are approached, C1 is the normalized Ca_{SP}T for half muscle activation, C2 is a slope of activation curve at C1, C3 is a scaling factor for temperature, C4 is the normalized Ca_{SP}T for maximum time constant, and C5 determines width of the bell-shaped τ_{Ã} curve.

15. The modeling system as set forth in claim 14, wherein the second step updates the Ã(t) to the A(t) in exponential form as (Ã)^{α} with an exponent α assuming the reduction in likelihood of cross-bridge formation under impulse stimulation relative to the steady case for the transient Ca_{SP} variation during electrical excitation.

16. The modeling method as set forth in claim 11, wherein the third step transforms the activation dynamics to the muscle force based on the simplest form of Hill-based muscle models that consists of contractile and serial elastic element in series as following equation (12)-(15):
F=P₀·K_{SE}·(ΔXₘ−ΔX_{CE}) (12)
$$\begin{matrix}{X}_{CE}^{*} = \frac{- {b}_{0} \cdot ( {P}_{0} \cdot g ( {X}_{m} ) \cdot A ( t ) - F )}{F + {a}_{0} \cdot g ( {X}_{m} ) \cdot A ( t )} for F \leq {P}_{0} \cdot g ( {X}_{m} ) \cdot A ( t ) & ( 13 ) \\ {X}_{CE}^{*} = \frac{- {d}_{0} \cdot ( {P}_{0} \cdot g ( {X}_{m} ) \cdot A ( t ) - F )}{2 {P}_{0} \cdot g ( {X}_{m} ) \cdot A ( t ) - F + {c}_{0} \cdot g ( {X}_{m} ) \cdot A ( t )} \\ for P > {P}_{0} \cdot g ( {X}_{m} ) \cdot A ( t ) & ( 14 ) \\ g ( {X}_{m} ) = exp \{ - {( \frac{{X}_{m} - {g}_{1}}{{g}_{3}} )}^{2} \} & ( 15 )\end{matrix}$$
where P₀ is the maximum muscle force at optimal muscle length, K_{SE} is the stiffness of the serial elastic element normalized with P₀, a₀, b₀, c₀ and d₀ are Hill-Mashma equation coefficients, g(Xₘ) is function of length-tension relation of muscle as a Gaussian function normalized with the P₀, g1-g3 are Gaussian coefficients indicating scaling factor, optimal muscle length and range of muscle length change, respectively.

17. The modeling method as set forth in claim 16, wherein a₀, b₀, c₀ and d₀ in the equations 14 and 15 are analytically determined based on length-tension (L-T) and velocity-tension (V-T) property by deriving inverse equations for the four coefficients given four data points ((V_{S,1}, T_{S,1}), (V_{S,2}, T_{S,2}), (V_{L,1}, T_{L,1}), (V_{L,2}, T_{L,2})) on V-T curve where V_{S,1} and V_{S,2} are minimum and maximum shortening velocities, and V_{L,1} and V_{L,2} are minimum and maximum lengthening velocities as following equations 16 to 19:
$$\begin{matrix}{a}_{0} = \frac{{V}_{S , 1} \cdot {T}_{S , 1} \cdot ( {P}_{0} - {T}_{S , 2} ) - {V}_{S , 2} \cdot {T}_{S , 2} \cdot ( {P}_{0} - {T}_{S , 1} )}{{V}_{S , 2} \cdot ( {P}_{0} - {T}_{S , 1} ) - {V}_{S , 1} \cdot ( {P}_{0} - {T}_{S , 2} )} & ( 16 ) \\ {b}_{0} = \frac{{V}_{S , 2} \cdot {V}_{S , 1} \cdot ( {T}_{S , 1} - {T}_{S , 2} )}{{V}_{S , 1} \cdot ( {P}_{0} - {T}_{S , 2} ) - {V}_{S , 2} \cdot ( {P}_{0} - {T}_{S , 1} )} & ( 17 ) \\ {c}_{0} = \frac{\begin{matrix}( 2 \cdot {V}_{L , 2} \cdot {P}_{0} - {V}_{L , 2} \cdot {T}_{L , 2} ) \cdot ( {P}_{0} - {T}_{L , 1} ) + \\ ( {V}_{L , 1} - {T}_{L , 1} - 2 \cdot {V}_{L , 1} \cdot {P}_{0} ) \cdot ( {P}_{0} - {T}_{L , 2} )\end{matrix}}{{V}_{L , 1} \cdot \{ {P}_{0} - {T}_{L , 2} - {V}_{L , 2} \cdot ( {P}_{0} - {T}_{L , 1} ) \}} & ( 18 ) \\ {d}_{0} = \frac{{V}_{L , 1} \cdot {V}_{L , 2} \cdot ( {T}_{L , 1} - {T}_{L , 2} )}{{V}_{L , 2} \cdot ( {P}_{0} - {T}_{L , 1} ) - {V}_{L , 1} \cdot ( {P}_{0} - {T}_{L , 2} )} . & ( 19 )\end{matrix}$$

18. The modeling method as set forth in claim 13, wherein a dependence of the activation dynamics on the muscle length during isometric and isokinetic contractions is compensated by making the rate constant (K5) of the Ca2+-troponin reaction a function of the muscle length (Xm) as following equation 20,
$$K {5}^{*} = ϕ ( {X}_{m} ) \cdot K 5 , \{ \begin{matrix}ϕ ( {X}_{m} ) = {ϕ}_{1} \cdot {X}_{m} + {ϕ}_{2} for {X}_{m} < optimal lengt • \\ ϕ ( {X}_{m} ) = {ϕ}_{3} \cdot {X}_{m} + {ϕ}_{4} for {X}_{m} \geq optimal length\end{matrix} \qquad ( 20 )$$
where φ₀-φ₄ is determined using a curve fit tool built in Matlab for the data set (φ(Xₘ), Xₘ).

19. The modeling method as set forth in claim 18, wherein the dependence of the activation dynamics on dynamic movement is compensated by adding a mathematical term to the exponent (α) of Ã(t) so that the α gradually increases during movement as following equation 21,
$$A = {( \tilde{A} )}^{α ( t )} , α ( t ) = α + {α}_{1} \cdot ( 1 + tanh \frac{t - {α}_{2}}{{α}_{3}} ) \qquad ( 21 )$$
where α₁, α₂ and α₃ is adjusted using the NEURON optimization tool to best fit the data at all three levels of constant frequency during movement.

20. The modeling method as set forth in claim 18, wherein the dependence of the activation dynamics on the muscle length and velocity during the dynamic movement is compensated as following equation 22,
$$A = \frac{{( \tilde{A} )}^{α ( t )}}{( 1 + β \cdot ϕ ( {X}_{m} ) ) \cdot ( 1 + γ \cdot ( {V}_{m} ) )} \\ where \\ α ( t ) = α + {α}_{1} \cdot ( 1 + tanh \frac{t - {α}_{2}}{{α}_{3}} ) , \qquad ( 22 )$$
α₁, α₂ and α₃ is adjusted using the NEURON optimization tool to best fit the data at all three levels of constant frequency during movement, φ(Xₘ) is the same function defined in equation 20, Vₘ are the time derivative of Xₘ, and β and γ were set to 0 for lengths longer than the optimal length or during negative velocity movement.
